(19) United States
(12) Patent Application Publication
(10) Pub. No.: US 2016/0255109 A1
(43) Pub. Date: Sep. 1, 2016

(54) DETECTION METHOD AND APPARATUS

(71) Applicant: FUJITSU LIMITED, Kawasaki-shi (JP)

(72) Inventors: Yusuke KOYANAGI, Kawasaki (JP); Yoshinori SAKAMOTO, Kawasaki (JP); Tateki IMAOKA, Chigasaki (JP); Masazumi MATSUBARA, Machida (JP); Kenji KOBAYASHI, Kawasaki (JP)

(73) Assignee: FUJITSU LIMITED, Kawasaki-shi (JP)

(21) Appl. No.: 15/048,716

(22) Filed: Feb. 19, 2016

(30) Foreign Application Priority Data
Feb. 26, 2015 (JP) 2015-036897

(51) Int. Cl. H04L 29/06; G06N 99/00

(52) U.S. Cl. CPC H04L 63/1425; H04L 63/1416; G06N 99/005

(57) ABSTRACT

A computer-readable recording medium contains a program for causing a computer to execute a process. The process includes executing multiple change point detection processes that detect respective change points of first time-series data with multiple granularities that are different in the width of a unit time. A first detection pattern that indicates the order of detection of the change points is stored in a storage part. Change points of second. time-series data subsequent to the first time-series data are detected with the different granularities. An output is generated that differs depending on whether a second detection pattern matches the stored first detection pattern. The second detection pattern indicates the order of detection of the change points of the second time-series data.

### CROSS-REFERENCE TO RELATED APPLICATION

This application is based upon and claims the benefit of priority of the prior Japanese Patent Application No. 2015-036897, filed on Feb. 26, 2015, the entire contents of which are incorporated herein by reference

### FIELD

A certain aspect of the embodiments discussed herein is related to detection methods and apparatuses.

### BACKGROUND

Anomaly detection techniques that use the time-series data of data detected with various sensors or log data are known (see, for example, Japanese Laid-Open Patent Publication Nos. 2009-217555 and 2003-256957). One method according to such anomaly detection techniques is to store a normal range of sensor values or normal log data as a normal pattern and determine whether object data are normal or not by comparing the object data with the stored normal pattern to verify the object data. Another method according to such anomaly detection techniques is to detect a change point of the feature value of object data (such as the volume of communication), which changes with time, without analyzing the data contents. For related art, reference may also be made to: Yamanishi, K. and J. Takeuchi; “Discovering outlier filtering rules from unlabeled data: combining a supervised learner with an unsupervised learner,” In Proceedings of the Seventh ACM SIGKDD International Conference on Knowledge Discovery and Data Mining (KDD01), ACM Press, 389-394, 2001; and Takeuchi, J. and K. Yamanishi; “A Unifying Framework for Detecting Outliers and Change Points from Time Series,” IEEE Transaction on Knowledge and Data Engineering, 18(4), 482-492, 2006.

### SUMMARY

According to an aspect of the invention, a computer-readable recording medium contains a program for causing computer to execute a process. The process includes executing multiple change point detection processes that detect respective change points of first time-series data with multiple granularities that are different in the width of a unit time. A first detection pattern that indica the order of detection of the change points is stored in a storage part. Change points of second time-series data subsequent to the first time-series data are detected with the different granularities. An output is generated that differs depending on whether a second detection pattern matches the stored first detection pattern. The second detection pattern indicates the order of detect ion of the change points of the second time-series data.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a block diagram illustrating an internal configuration of a detection apparatus according to an embodiment;

FIG. 2 is a diagram illustrating feature values of different widths, change points, and a detection pattern according to an embodiment;

FIG. 3 is a diagram illustrating a change. point history database according to a first embodiment;

FIG. 4 is a diagram illustrating a known pattern database according to the first embodiment;

FIG. 5 is a flowchart illustrating a detection pattern generation process according to the first embodiment;

FIG. 6 is a flowchart illustrating a learning process according to the first embodiment;

FIG. 7 is a flowchart illustrating a detection process according to the first embodiment;

FIG. 8 is a diagram illustrating a detection result according to the first embodiment;

FIG. 9 is a block diagram illustrating an internal configuration of a detection apparatus according to variations of the first embodiment;

FIG. 10 is a diagram illustrating a detection pattern history database according to a first variation of the first embodiment;

FIG. 11 is a flowchart illustrating a learning process according to the first variation of the first embodiment;

FIG. 12 is a flowchart illustrating a learning process according to a second variation of the first embodiment;

FIG. 13 is a diagram illustrating the change point history database according to the second variation of the first embodiment;

FIG. 14 is a flowchart illustrating a learning process according to a third variation of the first embodiment;

FIG. 15 is a diagram illustrating the change point history database according to the third variation of the first embodiment;

FIG. 16 is a diagram illustrating a detection pattern according to a second embodiment;

FIG. 17 is a flowchart illustrating a learning process according to the second embodiment;

FIG. 18 is a flowchart illustrating a detection process according to the second embodiment;

FIG. 19 is a diagram illustrating a detection result according to the second embodiment;

FIG. 20 is a diagram illustrating a det&ction pattern according to a third embodiment;

FIG. 21 is a flowchart illustrating a learning process according to the third embodiment;

FIG. 22 is a flowchart illustrating a detection process according to the third embodiment;

FIG. 23 is a diagram illustrating a detection result according to the third embodiment;

FIG. 24 is a flowchart illustrating a learning process according to a variation of the third embodiment;

FIG. 25 is a diagram illustrating a detection result according to the variation of the third embodittent;

FIG. 26 is a flowchart illustrating a detection process according to the variation of the third embodiment;

FIG. 27 is a block diagram illustrating an internal configuration of the detection apparatus according to a fourth embodiment;

FIG. 28 is a flowchart illustrating a learning process according to the fourth embodiment;

FIG. 29 is a diagram illustrating a learning result according to the fourth embodiment;

FIG. 30 is a flowchart illustrating a detection process according to the fourth embodiment;

FIG. 31 is a diagram illustrating a detection result according to the fourth embodiment;

FIG. 32 is a block diagram illustrating an internal configuration of the detection apparatus according to a fifth embodiment; and

FIG. 33 is a block diagram illustrating a hardware configuration of the detection apparatus according to an embodiment.

### DESCRIPTION OF EMBODIMENTS

As described above, anomaly detection techniques using time-series data include a method that determines the normality of object data by comparing the object data with a normal pattern and a method that detects a change point of the feature value of object data. The former method, however, takes time in determining the normality of object data by comparing the object data with a normal pattern.

According to the latter method, it is impossible to determine the meaning of a change point from the change point alone. Therefore, object data corresponding to the change point are eventually analyzed in order to determine whether the object data are normal or abnormal. Thus, the latter method also takes time in determining whether the object data are normal or not.

On the other hand, the stream data of sensor data or the like that are input for anomaly detection are large in amount. Therefore, there is a problem in that it is difficult to immediately report an event with a data analysis method that takes time in determining the anomaly of data.

According to an aspect of the present invention, object data are detected in less time.

Preferred embodiments of the present invention will be explained with reference to accompanying drawings. In the specification and drawings, elements having substantially the same functional configuration are referred to by the same reference numeral, and are not repetitively described.

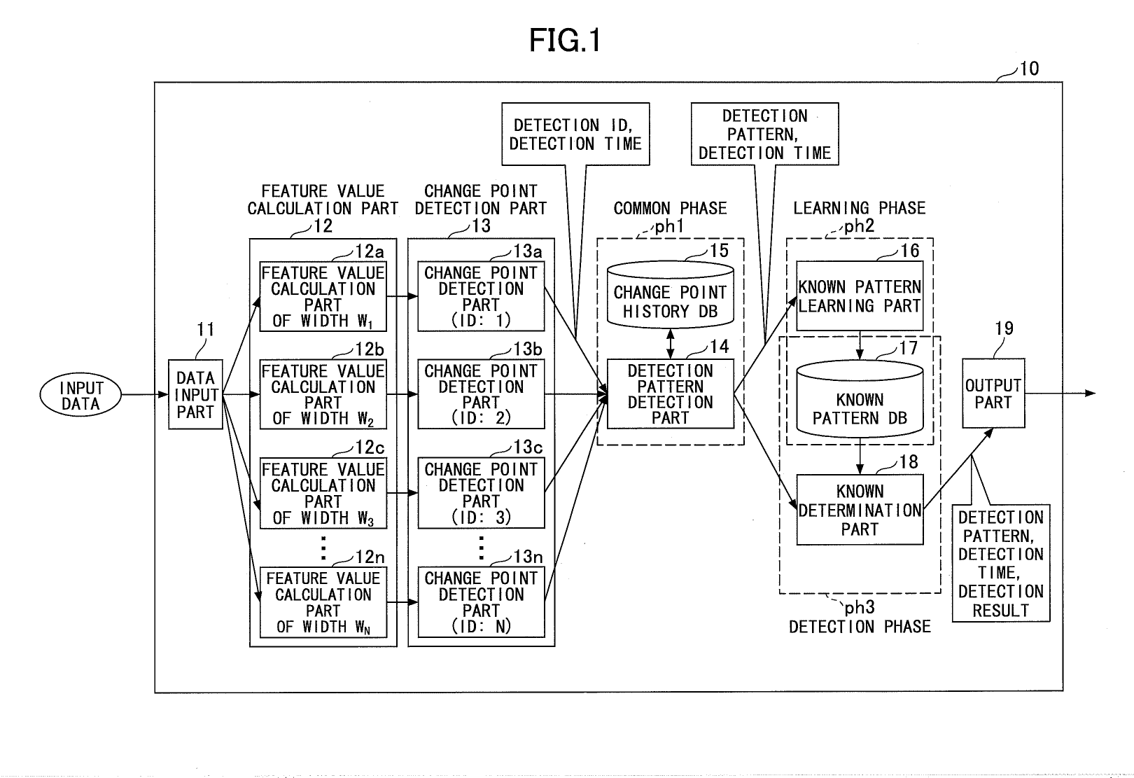

First, a description is given, with reference to FIG. 1, of an internal configuration of a detection apparatus 10 according to an embodiment of the present invention. The detection apparatus 10 detects a pattern of change points of feature value of the time-series data of data detected with various sensors or log data, and determines whether the detected pattern is known or unknown. Examples of the detection apparatus 10 include information processing apparatuses such as servers and personal computer (PC)s.

The detection apparatus 10 includes a data input part 11, a feature value calculation part 12, a change point detection part 13, a detection pattern detection part 14, a change point history database (DB) 15, a known pattern learning part 16, a known pattern DB 17, a known determination part 18, and an output part 19.

The data input part 11 inputs the time-series data of objects of assessment such as data detected with various sensors, communications data, a log data (hereinafter also referred to as “object data”).

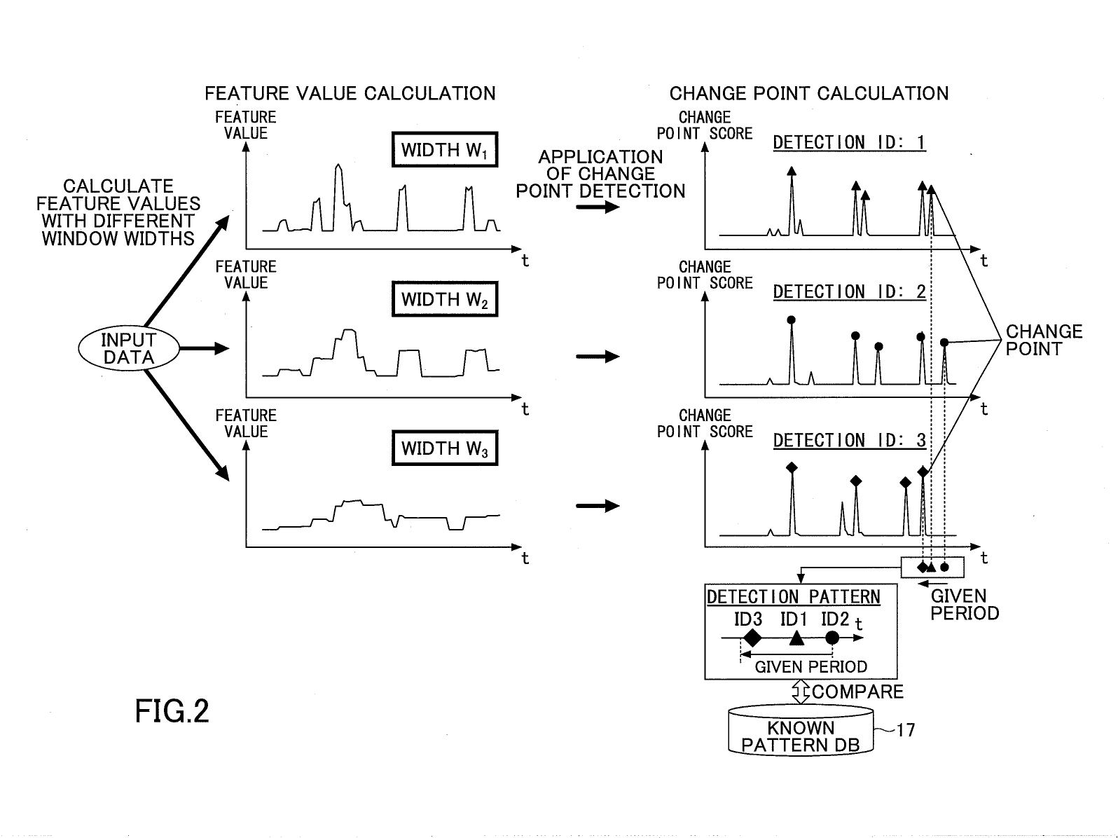

The feature value calculation part 12 extracts feature values of the object data. Examples of feature values of the object data include the ratio of communications to an external network. The feature value calculation part 12 calculates feature values of data groups of multiple granularities that are different in the window width of a unit time (hereinafter also referred to as “width”). For example, according to feature value calculation illustrated on the left side in FIG. 2, the feature value calculation part 12 calculates each of the feature values of data groups of object data that are included in dths of different given time periods extending back from a current time.

For example, Width W₁, Width W₂, and Width W₃ are defined as 10 minutes, 15 minutes, and 20 minutes, respectively. In this case, a feature value calculation part 12a of Width W₁ calculates the feature value of a data group obtained in the period of 10 minutes from 10 minutes before the current time to the current time (the feature value of Width W₁) (see top left graph in FIG. 2). A feature value calculation part 12b of Width W₂ calculates the feature value of a data group obtained in the period of 15 minutes from 15 minutes before the current time to the current time (the feature value of Width W₂) (see the middle left graph in FIG. 2). A feature value calculation part 12c of Width W₃ calculates the feature value of a data group obtained in the period of 20 minutes from 20 minutes before the current time to the current time (the feature value of Width W₃) (see the bottom left graph in FIG. 2).

As the granularity for feature value calculation becomes finer, smaller changes appear but with noise. Furthermore, while the feature value calculation part 12 calculates a feature value with respect to each of the three widths in the case of FIG. 2, the present invention is not limited to this example, and, for example, a feature value may be calculated with respect to n data groups of different widths, where n is an integer greater than or equal to two (n≧2).

The change point detection part 13 executes, with respect to object data, multiple change point detection processes that detect change ponts of feature values of multiple granularities that are different in the width of a unit time, and detect the degree of change of the feature values. The multiple change point detection processes may be carried out in change point detection units 13a, 13b, 13c . . . 13n corresponding to the feature value calculation parts of Widths W₁ through Wₙ 12a, 12b, 12c . . . 12n, respectively, as illustrated in FIG. 1. According to change point calculation illustrated on the right side in FIG. 2, a change point score is calculated with respect to each of the feature values of the data groups of Widths W₁, W₂, and W₃. The change point detection part 13 assigns a detection ID to the change point score detected with respect to each change point detection process. Referring to the change point calculation illustrated on the right side in FIG. 2, Detection ID “1,” Detection ID “2,” and Detection ID “3” are assigned in correspondence to the change point detection processes for the feature values of Widths W₁, W₂, and W₃, respectively.

In a common phase ph1 illustrated in FIG. 1, the detection pattern detection part 14 detects a detection pattern that includes detection order information. The detection order information indicates, in order, the three change point detection processes to which change points detected by the change point detection part 13 correspond. The history of detected change points is stored in the change point history DB 15. The detection order is indicated by the order of appearance of detection IDs.

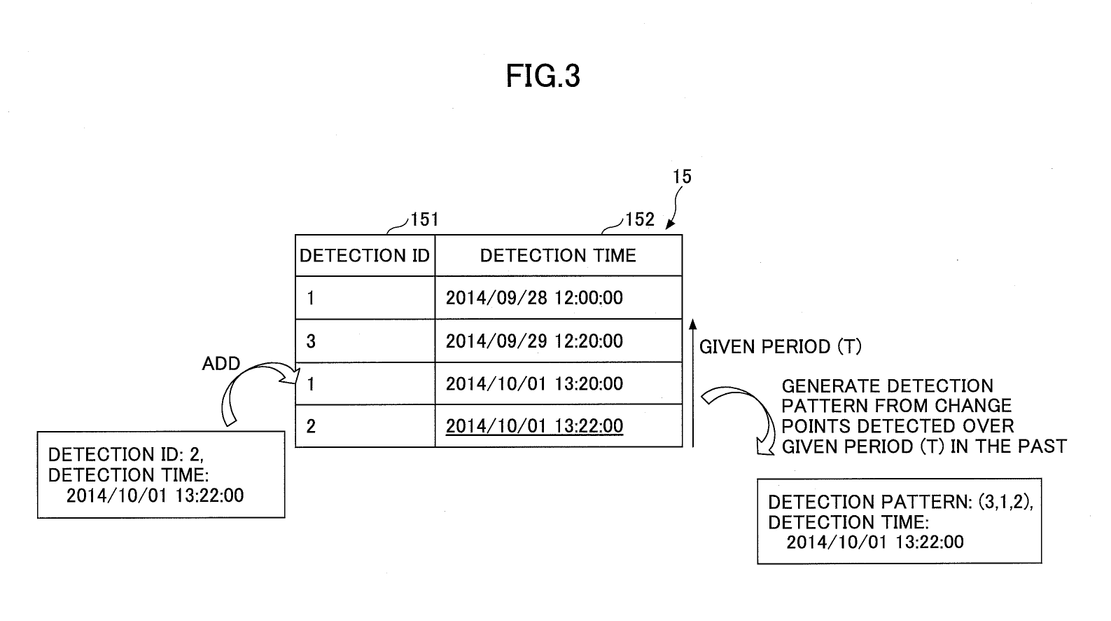

Specifically, the detection pattern detection part 14 obtains a detection ID and the detection time of a change point from the change point detection part 13, and stores the detection ID and the detection time of the change point in the change point history DB 15. By way of example, assuming that a circle indicated below the time axis of the bottom graph on the right side in FIG. 2 indicates a current time, the detection pattern detection part 14 determines, as a detection pattern, the order of appearance of the detection IDs of change points (a diamond, a triangle, and a circle) that appear in a given period extending back from the current time and are at or above a predetermined threshold. In this case, the order of appearance of the detection IDs is (3, 1, 2). The detection pattern is detected from the detection history of change points stored in the change point history DB 15. FIG. 3 illustrates an example of the change point history DB 15. The change point history DB 15 stores the information items of a detection ID 151 and a detection time 152 corresponding to the detection ID 151. The information of the detection pattern (3, 1, 2) of FIG. 2 is represented by the detection IDs 151 of “3,” “1,” and “2” and the detection times 152 corresponding to the detection IDs 151 in the change point history DB 15. The change point history DB 15 is an example of a storage part that stores the detection history of change point detection.

A learning phase ph2 described next is a phase for extracting a known pattern from detection patterns detected in the detection pattern detection part 14 and recording the extracted known pattern in the known pattern DB 17.

Furthermore, in a detection phase ph3, it is determined whether a new detection pattern detected with respect to new object data (data groups of Widths W₁, W₂, and W₃) is known or unknown, based on known patterns recorded in the known pattern DB 17 in the learning phase ph2.

Of the detection patterns detected in the detection pattern detection part 14, a detection pattern that is subjected to a determination as to whether the detection pattern is a known pattern or not in the learning phase ph2 is an example of “a first detection pattern.” The first detection pattern determined to be a known pattern is recorded in the known pattern DB 17.

On the other hand, a detection pattern that is subjected to a determination as to whether the detection pattern is a known pattern or not in the detection phase ph3 is an example of “a second detection pattern.” It is possible to determine whether the second detection pattern is known or unknown by comparing the second detection pattern with known patterns recorded in the known pattern DB 17.

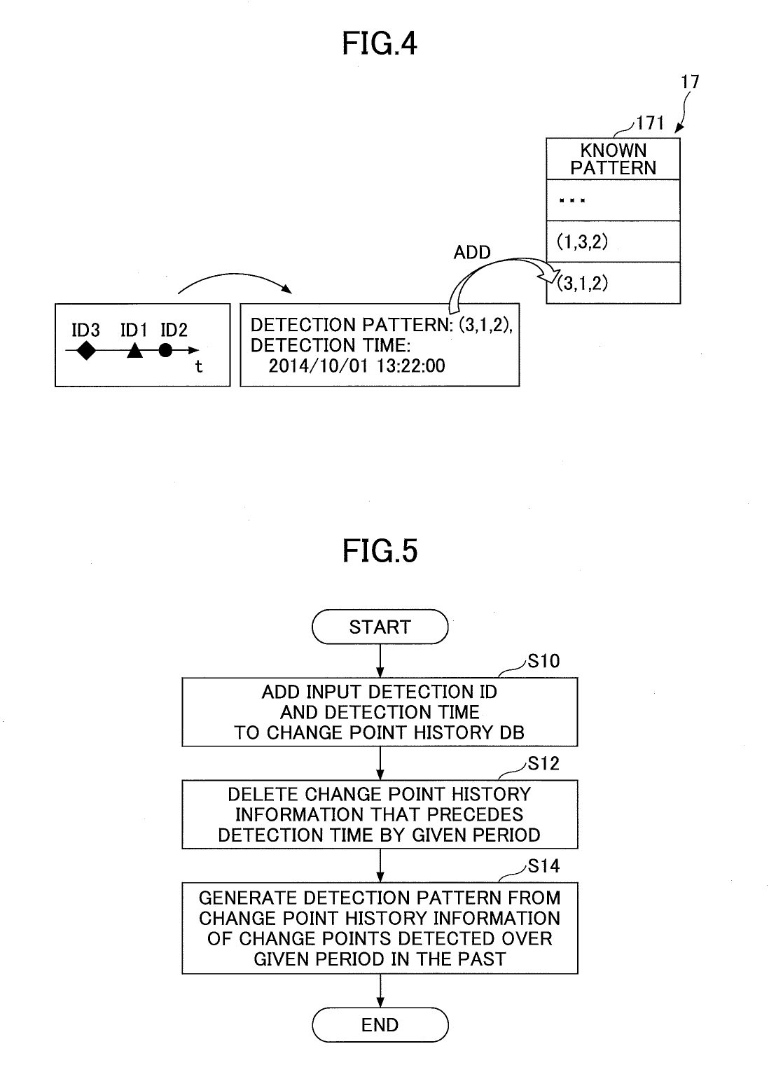

In the learning phase ph2, the known pattern learning part 16 extracts a known pattern from detection patterns detected in the detection pattern detection part 14, and stores the extracted detection pattern in the known pattern DB 17. For example, the known pattern learning part 16 determines, as a new known pattern, a detection pattern that is not stored in the known pattern DB 17 among the detection patterns detected in the detection pattern detection pat 14, and stores the detection patern in the known patten DB 17. FIG. 4 illustrates an example of the known pattern DB 17. A set of detection IDs indicating the order of detection of change points of the detection pattern (first detection pattern) determined to be a known pattern is stored. The known pattern DB 17 is an example of a storage part that stores known patterns extracted from detection patterns.

The timing of detection of change points differs among Widths W₁, W₂, and W₃, depending on how a feature value changes (the degree of change, the fineness of change, and conditions before a change). Accordingly, it is possible to identify how a feature value changes in each width based on the order of detection of change points obtained as a result of the detection of change points in Widths W₁, W₂, and W₃. Accordingly, the known pattern learning part 16 learns a known pattern indicating a group of change points existing in the past from the result of detection of change points with multiple granularities that are different in the width of a unit time.

In the detection phase ph3, the known determination part 18 determines whether a detection pattern (second detection pattern) with respect to new object data matches a known pattern stored in the known pattern DB 17 (a detection pattern determined to be a known pattern among the first detection patterns. The detection pattern (second detection pattern) that is subjected to the determination is the detection pattern of the change points detected within a given period in the common phase ph1 among the change points of data groups of the same widths as Widths W₁, W₂, and W₃ used in the detection of the first detection pattern.

In response to determining that the detection pattern matches a known pattern, the known determination part 18 determines that the detection pattern is “known.” In response to determining that the detection pattern matches no known pattern, the known determination part 18 determines that the detection pattern is “unknown.” As a result, it is possible to discriminate between a known detection pattern and an unknown detection pattern. The output part 19 reports the result of the determination in the detection phase ph3 to a user who has requested a determination of the object data.

It is possible to determine whether a detection pattern is known or unknown with higher accuracy with a larger number n of data groups of different widths.

### [a] First Embodiment

A description is given, with reference to FIG. 5, of a detection pattern generation process according to a first embodiment executed by the detection apparatus 10 of the above-described configuration. FIG. 5 is a flowchart illustrating a detection pattern generation process according to the first embodiment. When this process starts, at step S10, the detection pattern detection part 14 inputs a detection ID and a detection time, and adds the input detection ID and detection time to the change point history DB 15. For example, the detection pattern detection part 14 stores Detection ID “2” and a detection time “2014/10/01 13:22:00” of FIG. 3 in the change point history DB 15.

Next, at step S12, the detection pattern detection part 14 deletes a change point record preceding the stored detection time by a given period or more. For example, a detection ID and a detection time that precede the added detection time of Detection ID “2” by a given period or more are deleted from the change point history DB 15 of FIG. 3. Next, at step S14, the detection pattern detection part 14 generates a detection pattern from the change point history information of change points detected over a given period in the past extending back from the detection time, and ends this process. FIG. 3 illustrates the case where the detection pattern (3, 1, 2) is generated from the change point history information of change points detected over a given period in the past extending back from the detection time “2014/10/01 13:22:00”.

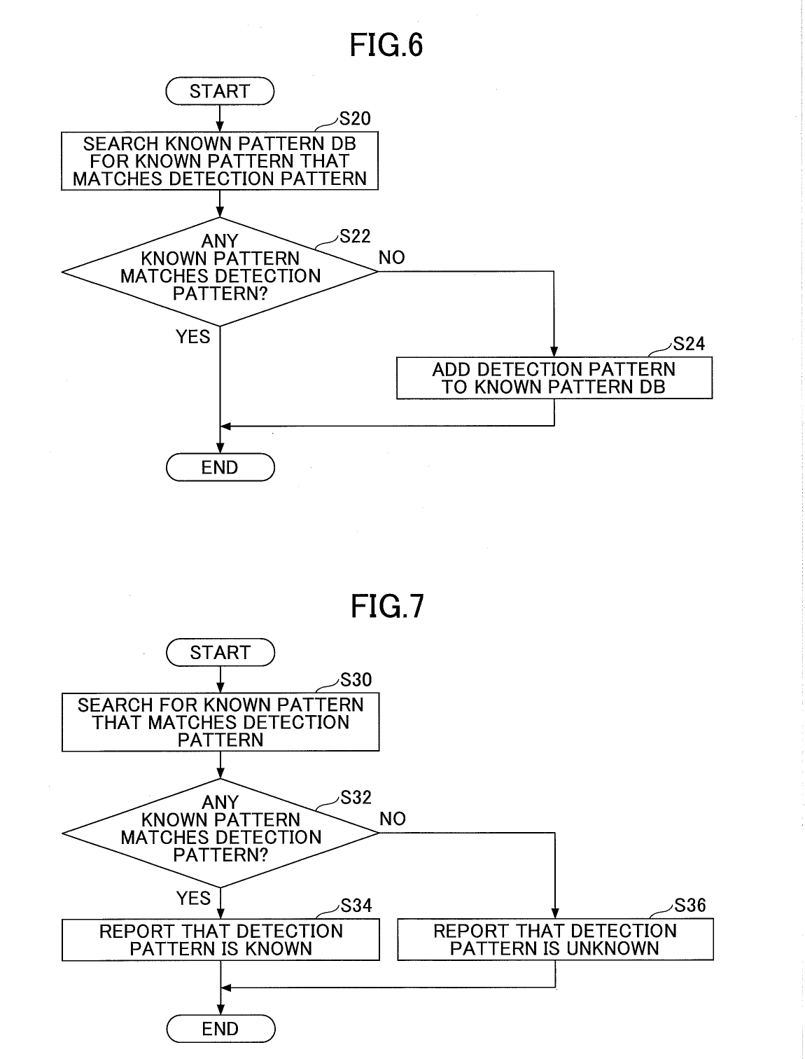

Next, a description is given, with reference to FIG. 6, of a learning process according to the first embodiment. FIG. 6 is a flowchart illustrating a learning process according to the first embodiment. When this process starts, at step S20, the known pattern learning part 16 searches the known pattern DB 17 for a known pattern that matches a detection pattern (first detection pattern). At step S22, the known pattern learning part 16 determines whether there is a known patten that matches the detection pattern. In response to determining that there is a known pattern that matches the detection pattern in the known pattern DB 17 (YES at step S22), the known pattern learning part 16 ends this process. On the other hand, in response to determining that there is no known pattern that matches the detection pattern in the known pattern DB 17 (NO at step S22), at step S24, the known pattern learning part 16 adds the detection pattern to the known pattern DB 17 as a known pattern, and ends this process. FIG. 4 illustrates the case where the detection pattern (3, 1, 2) that is not in the known pattern DB 17 is added to the known pattern DB 17 as a known pattern.

Next, a description is given, with reference to FIG. 7, of a detection process according to the first embodiment. FIG. 7 is a flowchart illustrating a detection process according to the first embodiment. When this process starts, at step S30, the known determination part 18 searches the known pattern DB 17 for a known pattern that matches a detection pattern to be assessed (a second detection pattern). At step S32, the known determination part 18 determines whether there is a known pattern that matches the detection pattern. In response to determining that there is a known pattern that matches the detection pattern (YES at step S32), at step S34, the known determination part 18 reports that the detection pattern is a known pattern, and ends this process.

On the other hand, in response to determining that there is no known pattern that matches the detection pattern (NO at step S32), at step S36, the known determination part 18 reports that the detection pattern is an unknown pattern, and ends this process.

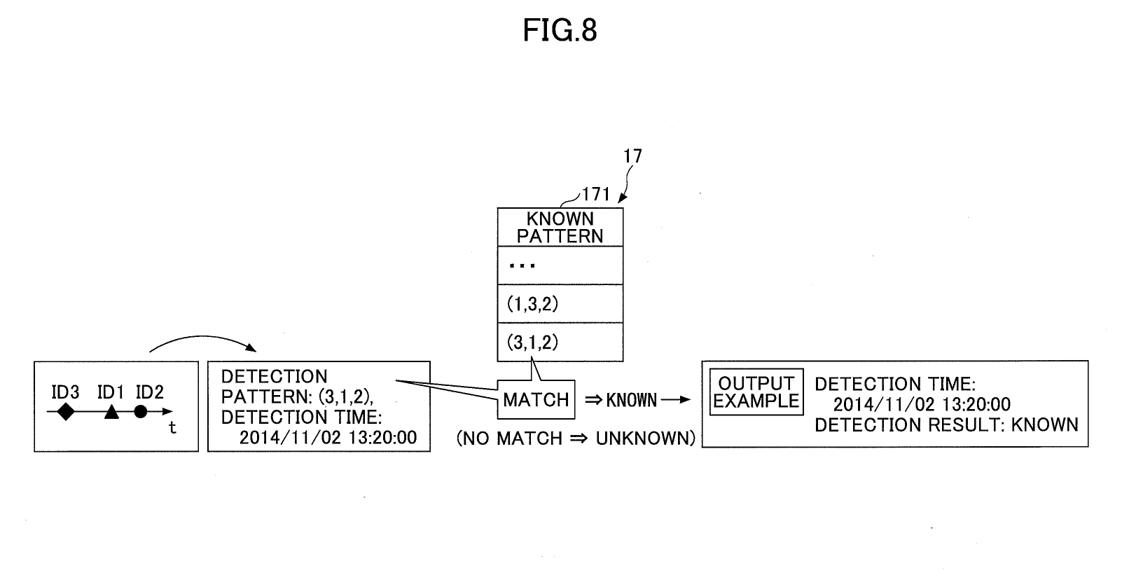

FIG. 8 illustrates the case where the detection pattern to be assessed (3, 1, 2) is in the known pattern DB 17 so that the output part 19 reports a determination result “KNOWN” and a detection time “2014/11/02 13:20:00”.

As described above, according to the detection apparatus 10 of the first embodiment, change points of feature values of object data are detected with multiple granularities that differ in the width of a unit time, and the order of detection (the order of appearance) of the detected change points is learned as a known pattern. Then, it is determined whether a new detection pattern is known or unknown based on whether the new detection pattern matches a learned known pattern. Thus, according to the detection apparatus 10 of the first embodiment, it is possible to perform a detection process on object data by comparing data on change points of feature values that are smaller in amount than the object data without analyzing the object data. As a result, it is possible to reduce a process time before determining whether the object data are known or unknown. In particular, a large amount of stream data of data to be processed, such as sensor data and log data, flow in. Therefore, according to this embodiment, it is possible to immediately report the event of detected data by reducing time before determining whether the detected data are known or unknown.

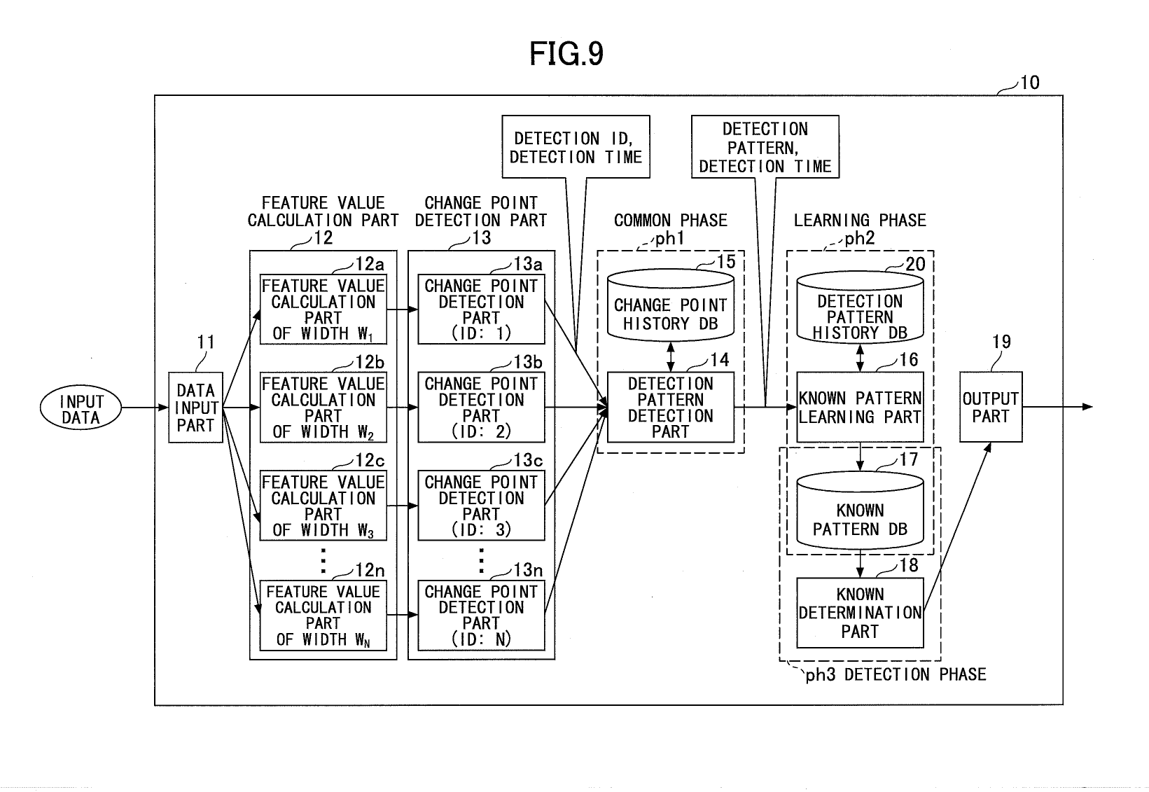

Next, a description is given, with reference to FIG. 9, of internal configurations of the detection apparatus 10 according to first, second, and third variations of the first embodiment. The detection apparatus 10 according to each variation of the first embodiment includes a detection pattern history DB 20 in addition to the configuration of the detection apparatus 10 according to the first embodiment illustrated in FIG. 1.

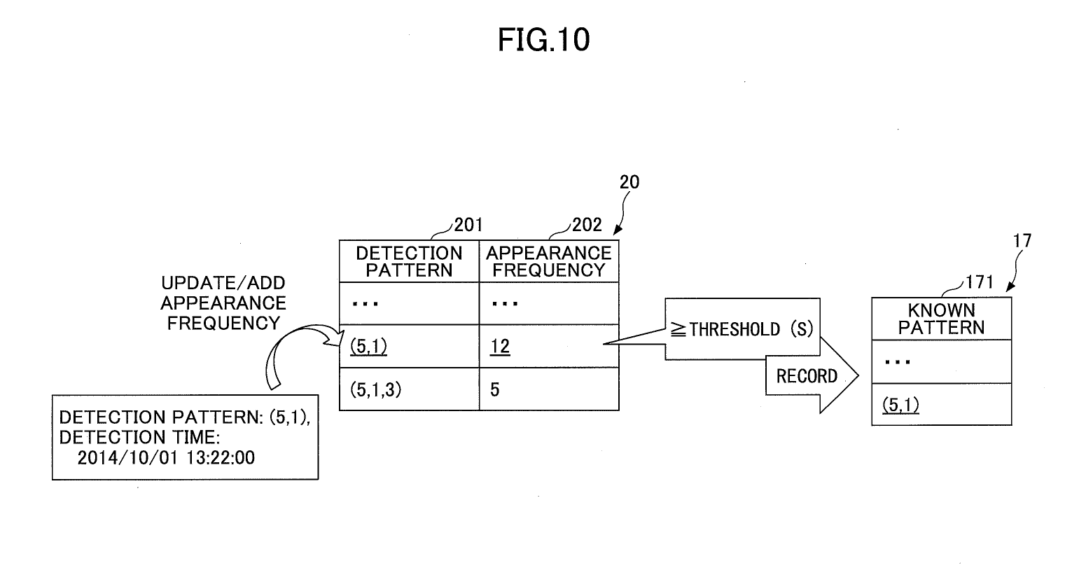

Referring to FIG. 10, the detection pattern history DB 20 includes one or more detection patterns 201 and one or more appearance frequencies 202 as detection result history information. According to the appearance frequency 202, the cumulative number of appearances of the detection pattern 201 is stored with respect to each detection pattern 201. It is determined whether a detection pattern is a known pattern based on the appearance frequency 202 of the detection pattern history DB 20.

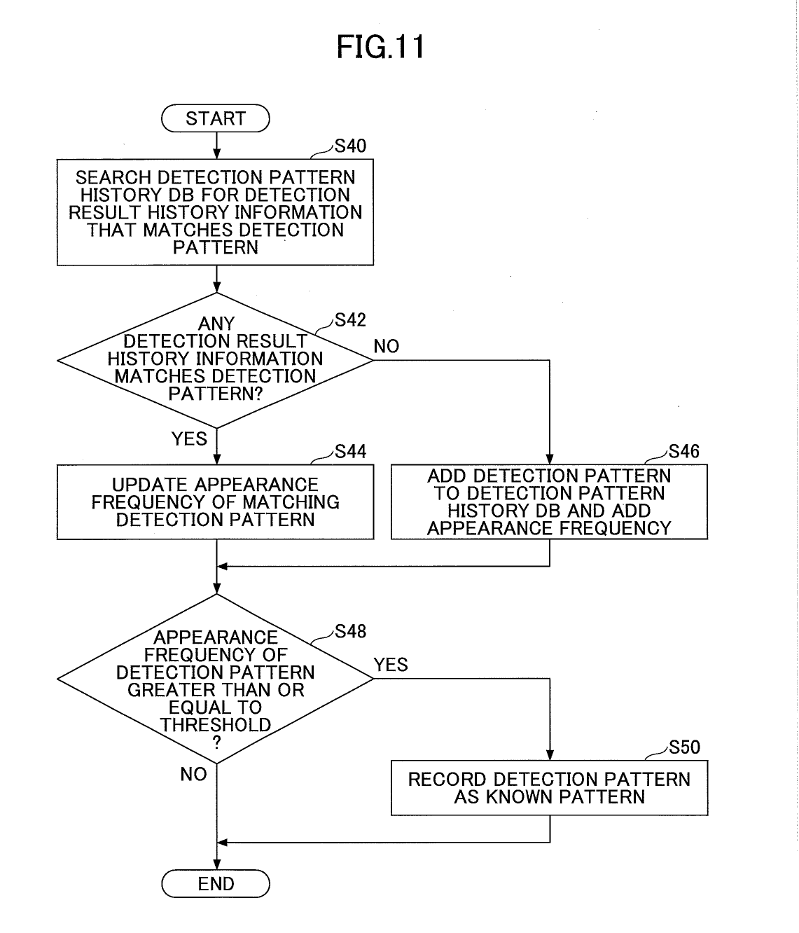

A description is given, with reference to FIG. 11, of a learning process according to the first variation of the first embodiment, executed by the detection apparatus 10 of the above-described configuration. FIG. 11 is a flowchart illustrating a learning process according to the first variation of the first embodiment. When this process starts, at step S40, the known pattern learning part 16 searches the detection pattern history DB 20 for the detection result history information of the detection pattern 201 that matches a detection pattern. At step S42, the known pattern learning part 16 determines whether there is the detection pattern 201 that matches the detection pattern. In response to determining that there is the detection pattern 201 that matches the detection pattern (YES at step S42), at step $44, the known pattern learning part 16 updates the appearance frequency of the matching detection pattern 201, and proceeds to step S48. On the other hand, in response to determining that there is no detection pattern 201 that matches the detection pattern (NO at step S42), at step S46, the known pattern learning part 16 adds the detection pattern to the detection pattern history DB 20 (as a new detection pattern 201), and adds the appearance frequency 202 of the added detection pattern 201. Then, the known pattern learning part 16 proceeds to step S48.

Next, at step S48, the known pattern learning part 16 determines whether the appearance frequency 202 of the detection pattern 201 is greater than or equal to a threshold S. In response to determining that the appearance frequency 202 is less than the threshold S (NO at step S48), the known pattern learning part 16 ends this process. On the other hand, in response to determining that the appearance frequency 202 is greater than or equal to the threshold S (YES at step S48), at step S50, the known pattern learning part 16 records the detection pattern 201 in the known pattern DB 17 as a known pattern, and ends this process.

According to the case illustrated in FIG. 10, the appearance frequency 202 of the detection pattern 201 (5, 1) is greater than or equal to the threshold S. Therefore, the detection pattern 201 (5, 1) is recorded in the known pattern DB 17. On the other hand, the appearance frequency 202 of the detection pattern 201 (5, 1, 3) is less than the threshold S. Therefore, the detection pattern 201 (5, 1, 3) is not recorded in the known pattern DB 17. The threshold S may be determined by a user of the detection apparatus 10.

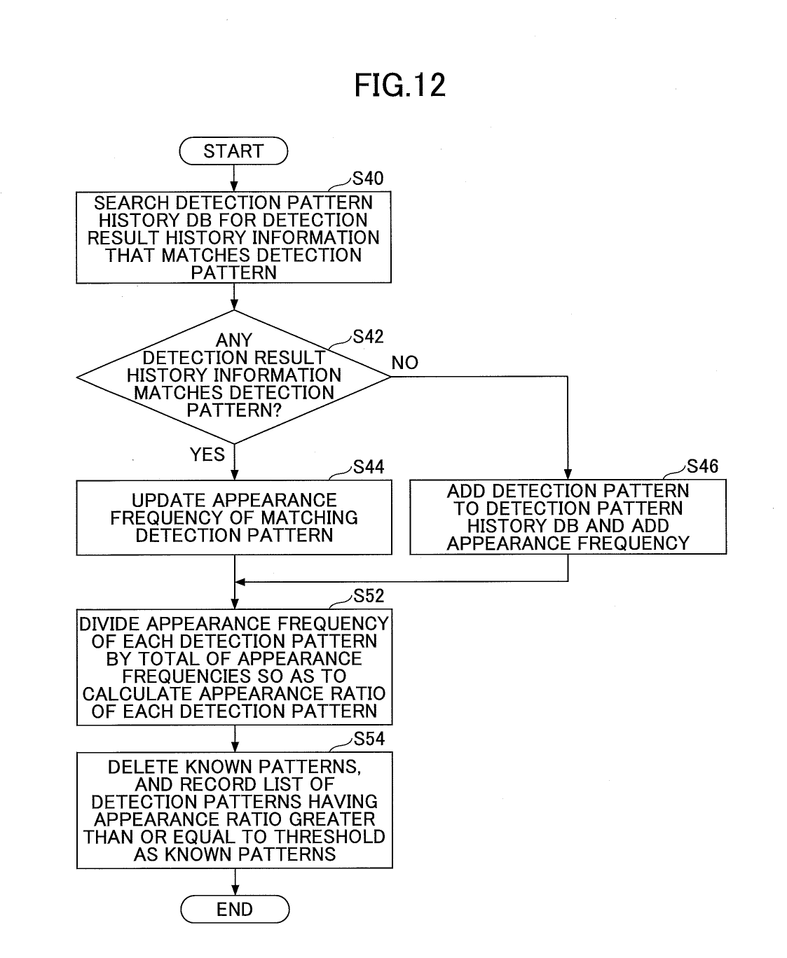

Next, a description is given, with reference to FIG. 12, of a learning process according to the second variation of the first embodiment. FIG. 12 is a flowchart illustrating a learning process according to the second variation of the first embodiment. When this process starts, steps S40 through S46 are executed the same as in the first variation, so that the appearance frequency 202 is updated or added to the detection pattern 201 stored in the detection pattern history DB 20.

Next, at step S52, the known pattern learning part 16 divides the appearance frequency 202 of each detection pattern 201 by the total of the appearance frequencies 202 so as to calculate the appearance ratio of each detection pattern 201. Then, at step S54, the known pattern learning part 16 erases the known patterns in the known pattern DB 17, and records a list of the detection patterns 201 having an appearance ratio greater than or equal to a threshold U in the known pattern DB 17 as known patterns. Then, the known pattern learning part 16 ends this process.

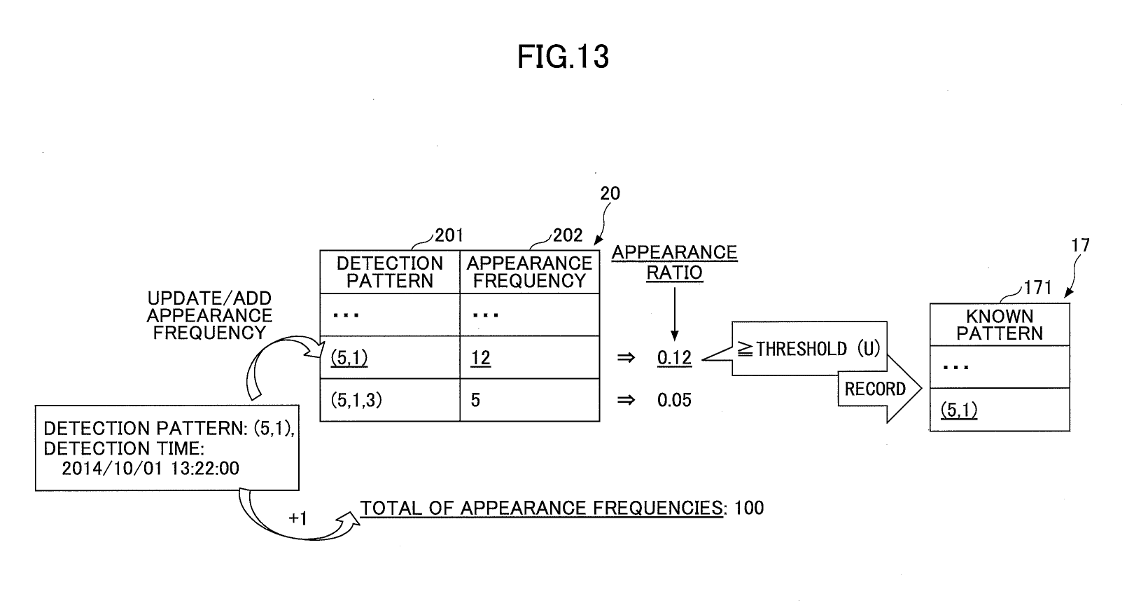

Referring to FIG. 13, the appearance ratio of each detection pattern 201 is calculated based on the appearance frequency 201 of each detection pattern 201 stored in the detection pattern history DB 20, and the detection patterns 201 having an appearance ratio greater than or equal to the threshold U are recorded in the known pattern DB 17. The threshold U may be determined by a user of the detection apparatus 10.

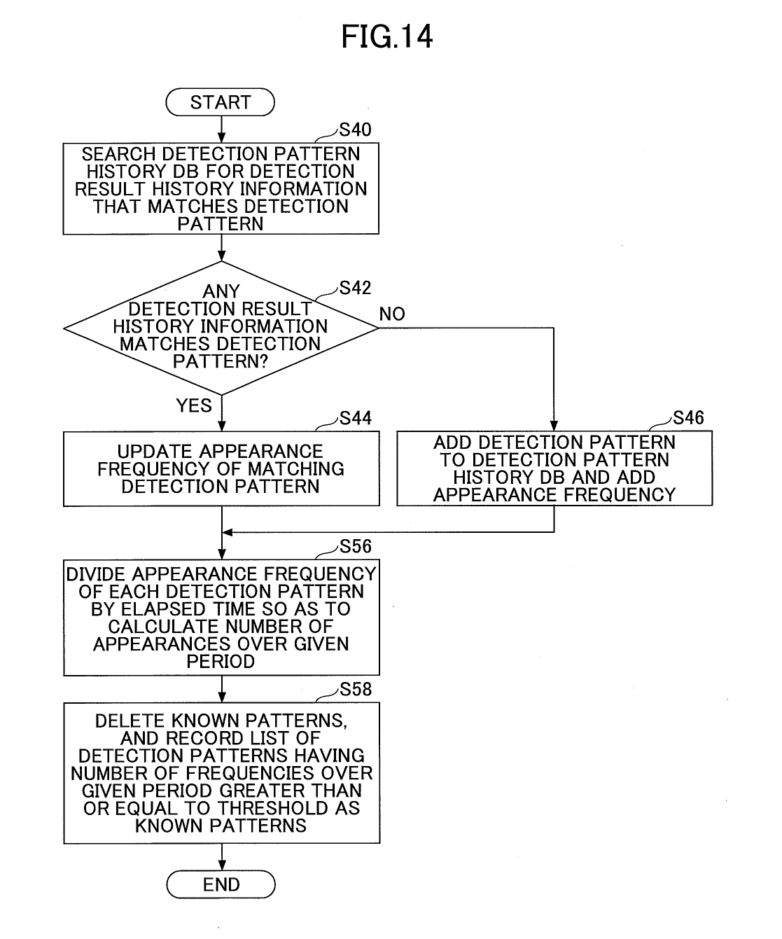

Next, a description is given, with reference to FIG. 14, of a learning process according to the third variation of the first embodiment. FIG. 14 is a flowchart illustrating a learning process according to the third variation of the first embodiment. When this process starts, steps S40 through S46 are executed the same as in the first variation, so that the appearance frequency 202 is updated or added to the detection pattern 201 stored in the detection pattern history DB 20.

Next, at step S56, the known pattern learning part 16 divides the appearance frequency 202 of each detection pattern 201 by elapsed time so as to calculate the number of appearances of each detection pattern 201 over a given period. Next, at step S58, the known pattern learning part 16 erases the known patterns in the known pattern DB 17, and records a list of the detection patterns 201 having the number of appearances over a given period that is greater than or equal to a threshold V in the known pattern DB 17 as known patterns. Then, the known pattern learning part 16 ends this process.

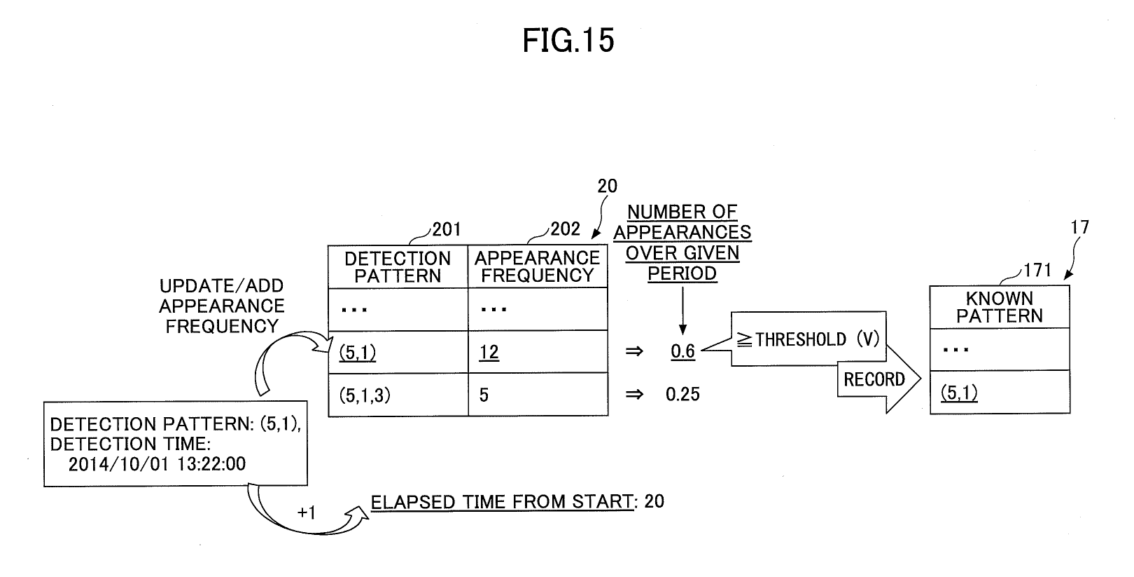

Referring to FIG. 15, the number of appearances of the detection pattern 201 of (5, 1) over a given period, “0.6,” is calculated by dividing the appearance frequency 202 of the detection pattern 201 of (5, 1) stored in the detection pattern history DB 20 by the time that has elapsed from the start, “20,” for example. When the number of appearances over a given period “0.6” is greater than or equal to the threshold V, the detection pattern 201 of (5, 1) is recorded in the known pattern DB 17. The threshold V may be determined by a user of the detection apparatus 10.

Thus, according to the first through third variations of the first embodiment, in the detection apparatus 10, it is possible to learn a known pattern based on a comparison with a predetermined threshold in the learning phase ph2. For example, according to the first variation, a detection pattern whose appearance frequency is greater than or equal to the threshold S is recorded in the known pattern DB 17 as a known pattern. According to the second variation, a detection pattern whose appearance ratio is greater than or equal to the threshold U is recorded in the known pattern DB 17 as a known pattern. According to the third variation, a detection pattern whose number of appearances over a given period is greater than or equal to the threshold V is recorded in the known pattern DB 17 as a known pattern. As a result, it is possible to determine a known pattern to be recorded in view of the appearance frequency of a detection pattern in the learning phase ph2, so that it is possible to increase the accuracy of a determination as to whether a detection pattern is known or unknown in the detection phase ph3.

### [b] Second Embodiment

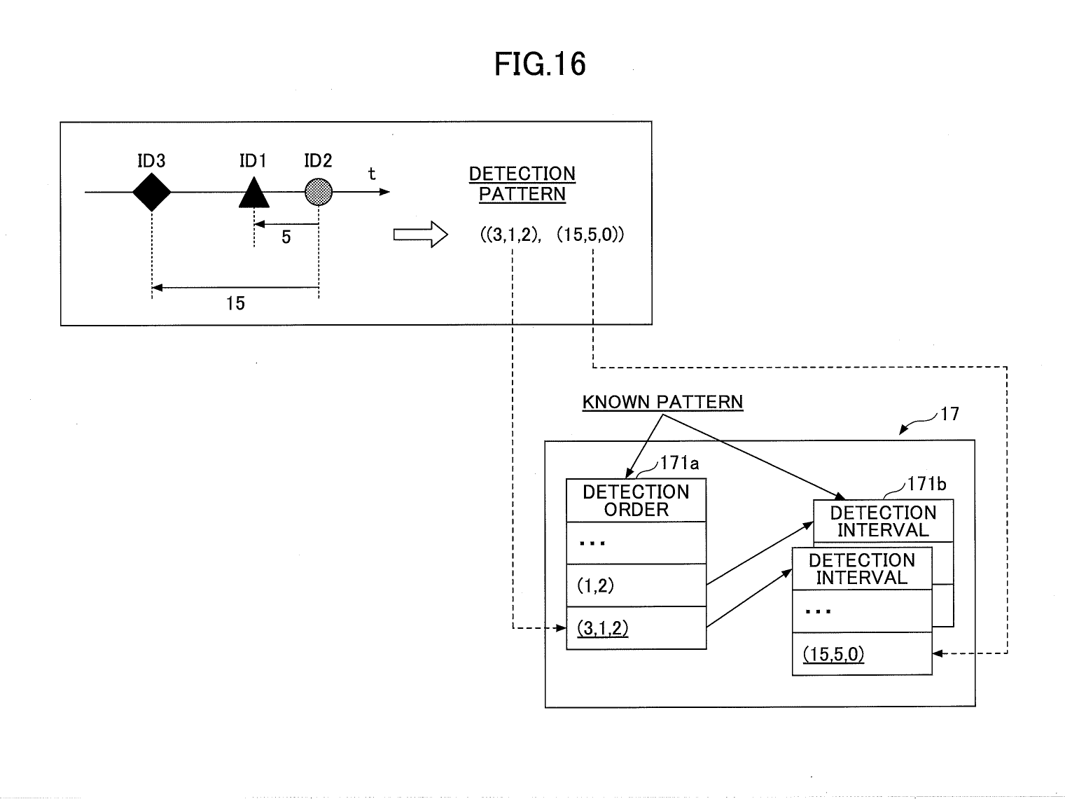

According to the detection apparatus 10 of the first embodiment as described above, a known pattern is learned or detected based on the order of detection of change points. On the other hand, according to the detection apparatus 10 according to a second embodiment described below, a known pattern is learned or detected based on the order of detection and the intervals of detection (appearance intervals) of change points. For example, referring to FIG. 16, according to the second embodiment, a detection pattern includes the information of a detection order (3, 1, 2) and a detection interval (15, 5, 0). The detection interval (15, 5, 0) indicates time differences from the detection time of DETECTION ID “2,” which is a current time. That is, the detection interval (15, 5, 0) indicates a time difference (interval) of “15” between DETECTION ID “3” and DETECTION ID “2,” a time difference (interval) of “5” between DETECTION ID “1” and DETECTION ID “2,” and a time difference (interval) of “0” between DETECTION ID “2” and DETECTION ID “2.”

The known pattern DB 17 stores one or more detection orders 171a and one or more detection intervals 171b. Even when the detection orders 171a of detection patterns are the same, the detection patterns are stored different known patterns when the detection intervals 171b of the detection patterns are different. One or more detection intervals 171b may be recorded with respect to each detection order 171a.

The detection apparatus 10 according to the second embodiment may have the same internal configuration as the detection apparatus 10 illustrated in FIG. 1. Accordingly, a description of the internal cofiguration of the detection apparatus 10 according to the second embodiment is omitted. In the following, a description is given step by step of a learning process and a detection process according to the second embodiment.

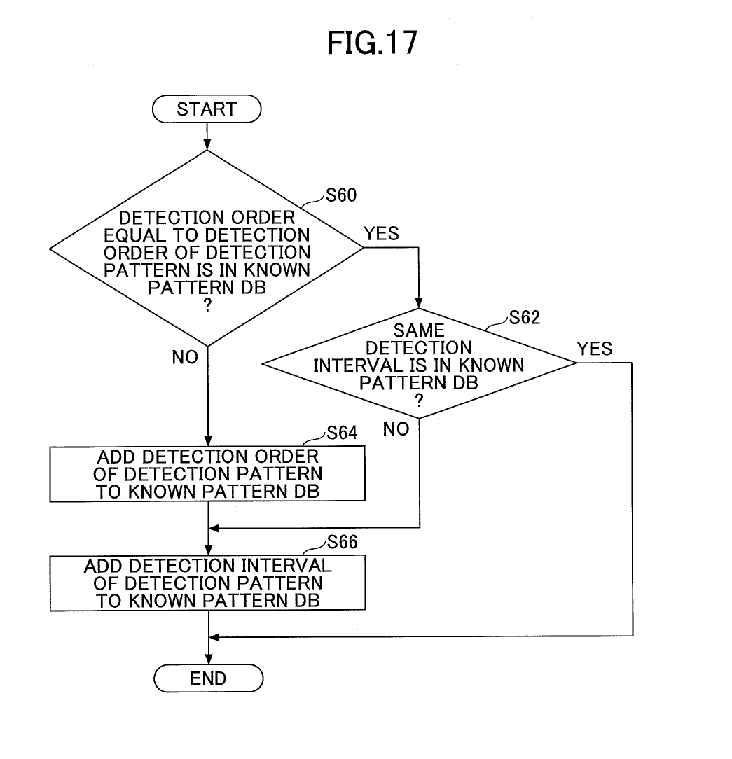

First, a description is given, with reference to FIG. 17, of a learning process according to the second embodiment. FIG. 17 is a flowchart illustrating a learning process according to the second embodiment. When this process starts, at step S60, the known pattern learning part 16 determines whether there is the detection order of a known pattern that matches the detection order of a detection pattern in the known pattern DB 17. In response to determining that there is a known pattern that has a matching detection order in the known pattern DB 17 (YES at step S60), at step S62, the known pattern learning part 16 determines whether there is a known pattern whose detection interval matches the detection interval of the detection pattern among the known patterns having the matching detection order. In response to determining that there is a known pattern whose detection interval matches the detection interval of the detection pattern (YES at step S62), the known pattern learning part 16 ends this process.

On the other hand, in response to determining that there is no known pattern whose detection interval matches the detection interval of the detection pattern among the known patterns having the matching detection order (NO at step S62), at step S66, the known pattern learning part 16 records the detection interval of the detection pattern in the known pattern DB 17, and ends this process.

In response to determining at step S60 that there is no known pattern that has a matching detection order in the known pattern DB 17, at step S64, the known pattern learning part 16 records the detection order of the detection pattern in the known pattern DB 17. Then, at step S66, the known pattern learning part 16 records the detection interval of the detection pattern in the known pattern DB 17, and ends this process.

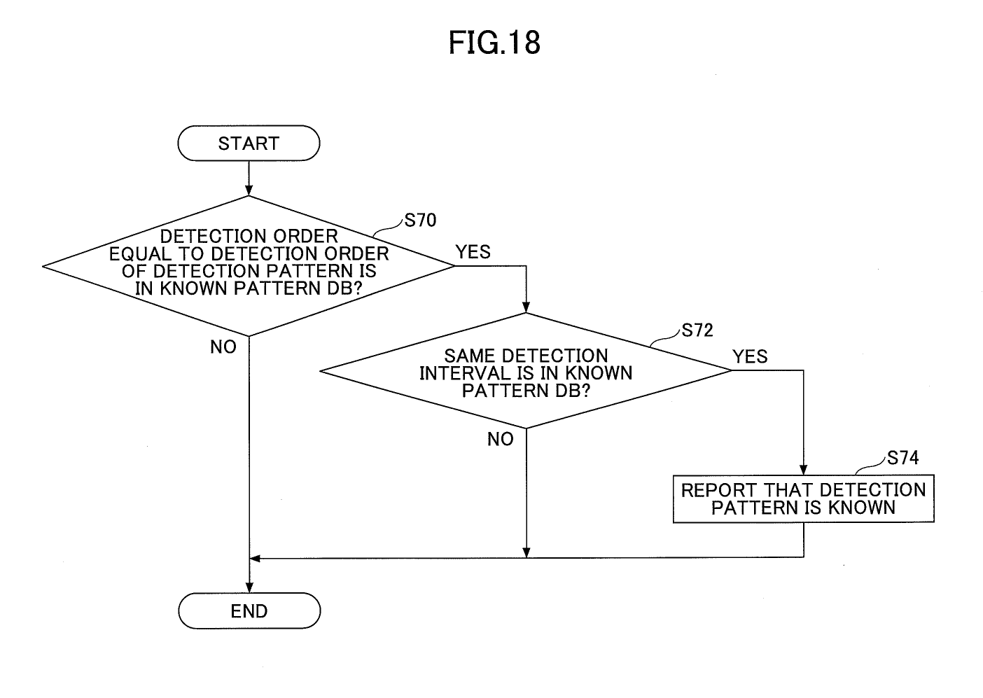

Next, a description is given, with reference to FIG. 18, of a detection process according to the second embodiment. FIG. 18 is a flowchart illustrating a detection process according to the second embodiment. When this process starts, at step S70, the known determination part 18 searches the known pattern DB 17 for a known pattern whose detection order matches the detection order of a detection pattern. In response to determining that there is no known pattern whose detection order matches the detection order of the detection pattern in the known pattern DB 17 (NO at step S70), the known determination part 18 ends this process.

On the other hand, in response to determining that there is a known pattern whose detection order matches the detection order of the detection pattern in the known pattern DB 17 (NO at step S70), at step S72, the known determination part 18 determines whether there is a known pattern whose detection interval matches the detection interval of the detection pattern among the known patterns having the matching detection order. In response to determining that there is a known pattern whose detection interval matches the detection interval of the detection pattern among the known patterns having the matching detection order (YES at step S72), at step S74, the known determination part 18 reports that the detection pattern is known, and ends this process. In response to determining that there no known pattern whose detection interval matches the detection interval of the detection pattern among the known patterns having the matching detection order (NO at step S72), the known determination part 18 ends this process.

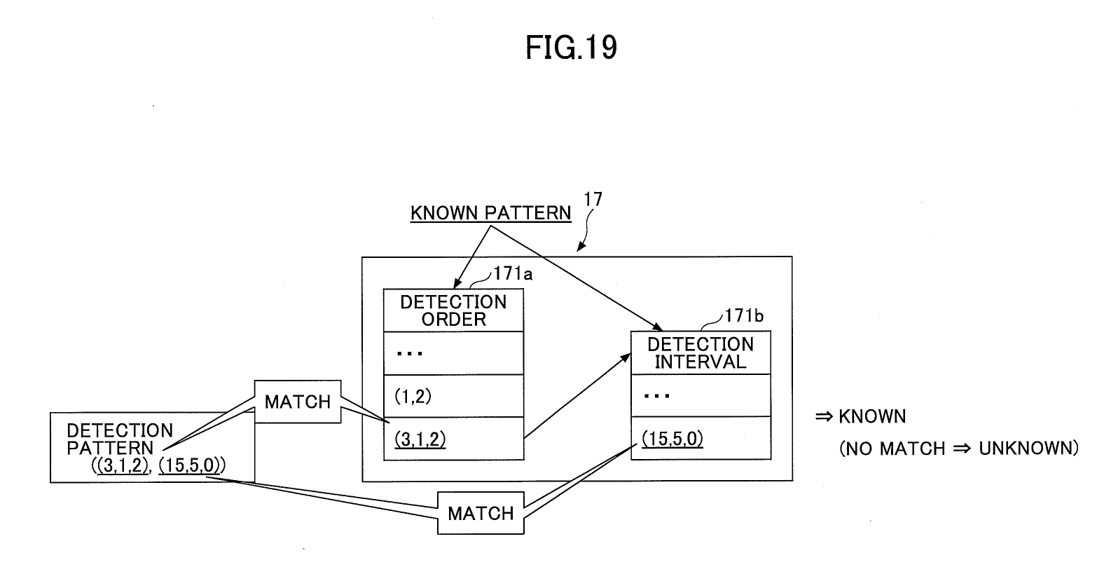

Referring to FIG. 19, for example, the detection order (3, 1, 2) of a detection pattern matches the detection order 171a (3, 1, 2) of a known pattern and the detection interval (15, 5, 0) of the detection pattern matches the detection inteval 171b (15, 5, 0) of the known pattern in the known pattern DB 17. In this case, the detection pattern is determined to be known. On the other hand, if at least one of the detection order and the detection interval of the detection pattern has no match, the detection pattern is determined to be unknown.

As described above, according to the detection apparatus 10 of the second embodiment, it is possible to more finely identify change points for extracting a detection pattern with the detection order and the detection interval of the detection pattern. As a result, it is possible to determine whether a detection pattern is known or unknown with more accuracy based on whether the detection pattern matches a known pattern in detection order and detection interval.

### [c] Third Embodiment

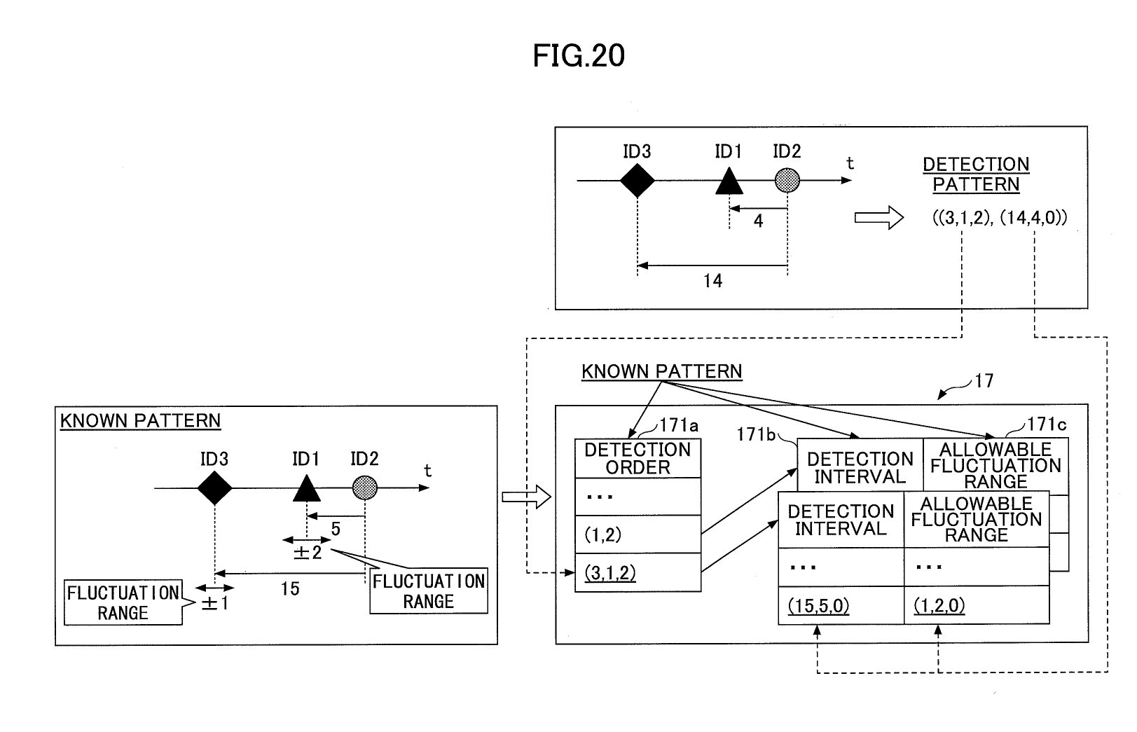

According to the detection apparatus 10 of the first embodiment as described above, a known pattern is learned or detected based on the order of detection of change points. According to the detection apparatus 10 of the second embodiment as described above, a known pattern is learned or detected based on the order of detection and the intervals of detection of change points. On the other hand, according to the detection apparatus 10 of a third embodiment as described below, a known pattern is learned or detected based on the order of detection and the intervals of detection of change points with the allowable range of fluctuations of the intervals of detection being further provided. According to the third embodiment, a detected detection pattern of change points has the information of the order of detection and the intervals of detection the same as in the second embodiment. For example, the detection order and the detection interval of a detection pattern illustrated in FIG. 20 are (3, 1, 2) and (14, 4, 0), respectively. According to the third embodiment, along with the detection orders 171a and the detection intervals 171b, one or more allowable ranges of fluctuations (allowable fluctuation ranges) 171c with respect to the detection intervals 171b are stored in the known pattern DB 17. In the detection phase ph3, even when the detection interval of a detection pattern does not exactly match the detection interval of a known pattern, the detection pattern is determined to be known if the difference between the detection intervals is within the corresponding allowable fluctuation range 171c.

For example, when the detection order 171a is (3, 1, 2), the detection interval 171b is (15, 5, 0), and the allowable fluctuation range 171c is (1, 2, 0) in the known pattern DB 17, the detection order (3, 1, 2) of the detection pattern matches the detection order 171a (3, 1, 2) of a known pattern. The detection interval (14, 4, 0) of the detection pattern, however, does not match the detection interval 171b (15, 5, 0) of the known pattern. In this case, the detection pattern is determined to be unknown in the detection phase ph3 according to the second embodiment.

On the other hand, according to the third embodiment, the detection interval (14, 4, 0) of the detection pattern is included in the allowable detection intervals (15±1, 5±2, 0±0) of the known pattern. As a result, the detection pattern is determined to be known,

The detection apparatus 10 according to the third embodiment may have the same internal configuration as the detection apparatus 10 illustrated in FIG. 9. Accordingly, a description of the internal configuration of the detection apparatus 10 according to the third embodiment is omitted. In the following, a description is given step by step of a learning process and a detection process according to the third embodiment.

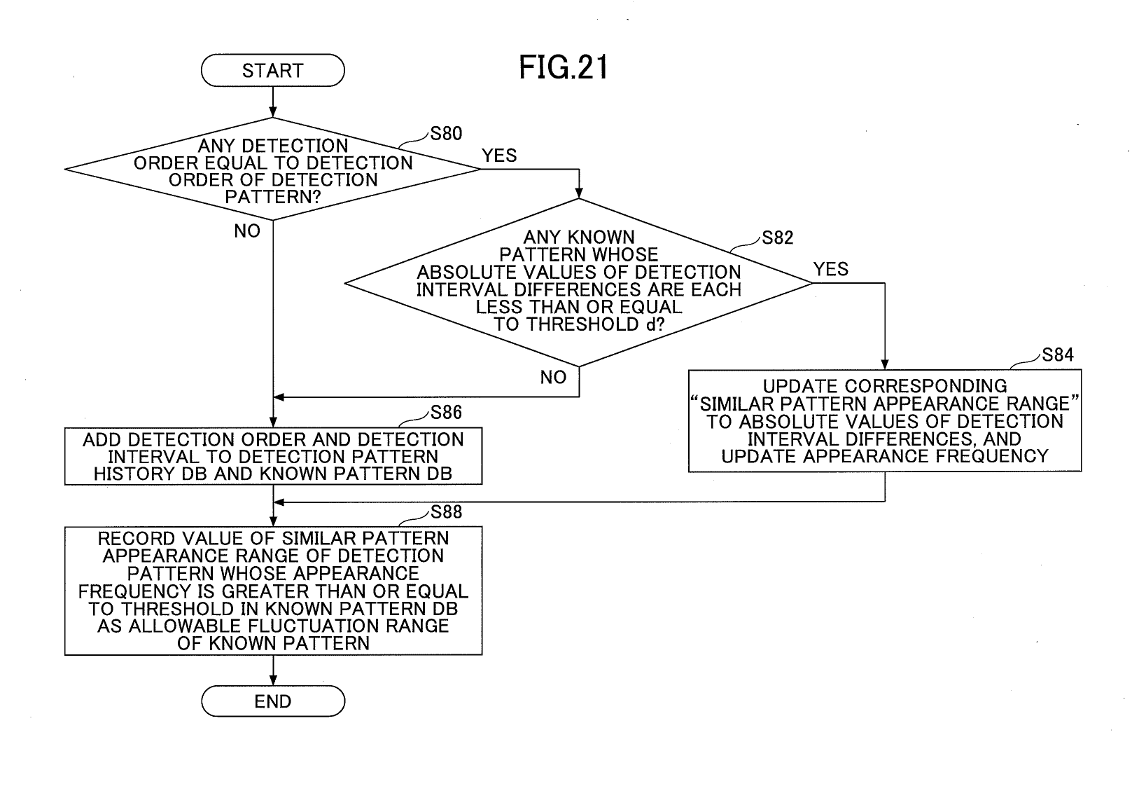

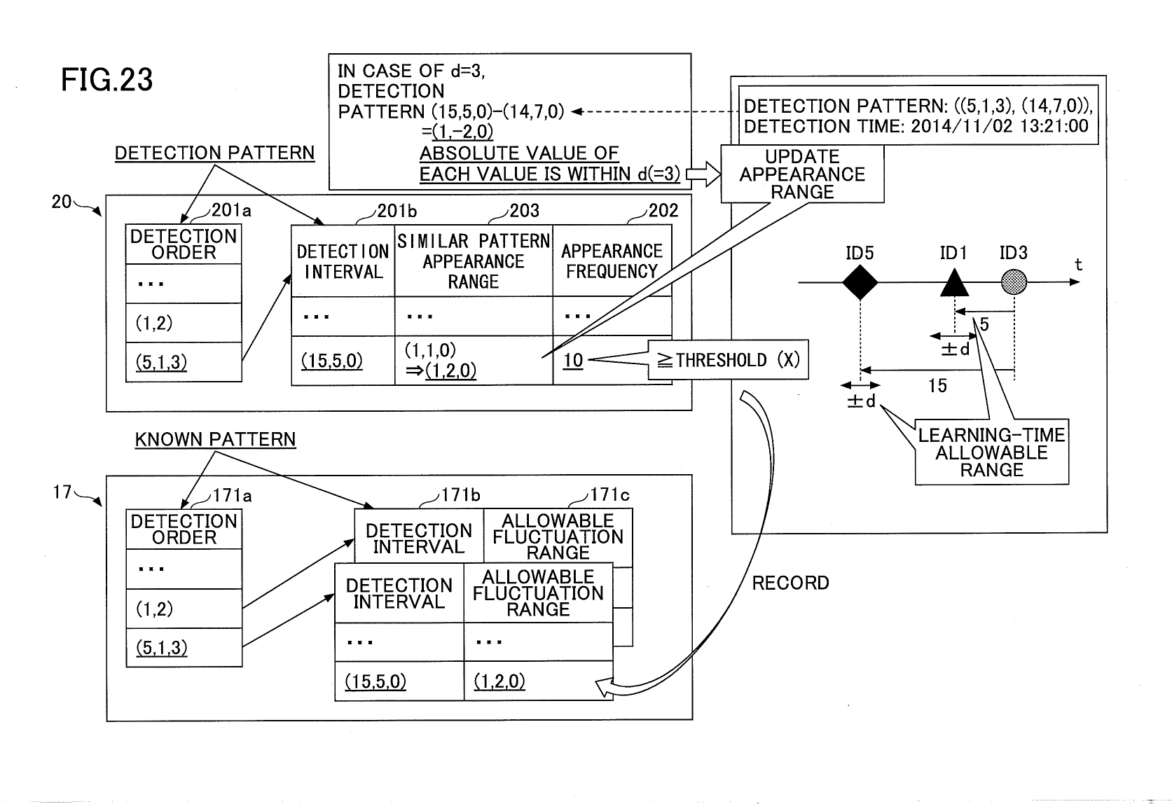

First, a description is given, with reference to FIG. 21, of a learning process according to the third embodiment. FIG. 21 is a flowchart illustrating a learning process according to the third embodiment. When this process starts, at step S80, the known pattern learning part 16 determines whether there is the detection order 171a of a known pattern that matches the detection order of a detected detection pattern in the known pattern DB 17. In response to determining that there is a known pattern that has the matching detection order 171a in the known pattern DB 17 (YES at step S80), at step S82, the known pattern learning part 16 determines whether there is a known pattern stored in the known pattern DB 17 that has the detection order 171a equal to the detection order of the detected detection pattern and has the detection interval 171b whose differences in the individual detection intervals of change points from the detection interval of the detected detection pattern are each less than or equal to a threshold d (±3 in the case of FIG. 23 in absolute value.

In response to determining the presence of such a known pattern in the known pattern DB 17 (YES at step S82), at step S84, the known pattern learning part 16 updates a range of appearances of similar patterns (similar pattern appearance range) 203 of a corresponding detection pattern (having the same detection order 201a and detection interval 201b as the detection order 171a and detection interval 171b of the known pattern) in the detection pattern history DB 20 to the absolute values of the detection interval differences. Furthermore, the known pattern learning part 16 updates the appearance frequency 202 of the detection pattern (by incrementing the value by “1”).

For example, the similar pattern appearance range 203 of the detection pattern history DB 20 illustrated in FIG. 23 is updated to the absolute values of the differences in detection interval between the detection pattern and the known pattern, (1, 2, 0).

Referring back to FIG. 21, next, at step S88, the known pattern learning part 16 records the value of the similar pattern appearance range 203 in the allowable fluctuation range 171c of the known pattern DB 17 when the appearance frequency 202 of the detection pattern history DB 20 becomes greater than or equal to a threshold X, and ends this process.

On the other hand, in response to determining that there is no detection order 171a of a known pattern that matches the detection order of the detected detection pattern in the known pattern DB 17 (NO at step S80), at step S86, the known pattern learning part 16 adds the detection order and the detection interval of the detected detection pattern to the detection pattern history DB 20 and the known pattern DB 17. In response to determining the absence of such a known pattern in the known pattern DB 17 at step S82 (NO at step S82), at step S86, the known pattern learning part 16 adds the detection order and the detection interval of the detected detection pattern to the detection pattern history DB 20 and the known pattern DB 17. Next, at step S88, the known pattern learning part 16 records the value of the similar pattern appearance range 203 in the allowable fluctuation range 171c of the known pattern DB 17 when the appearance frequency 202 of the detection pattern history DB 20 becomes greater than or equal to the threshold X, and ends this process.

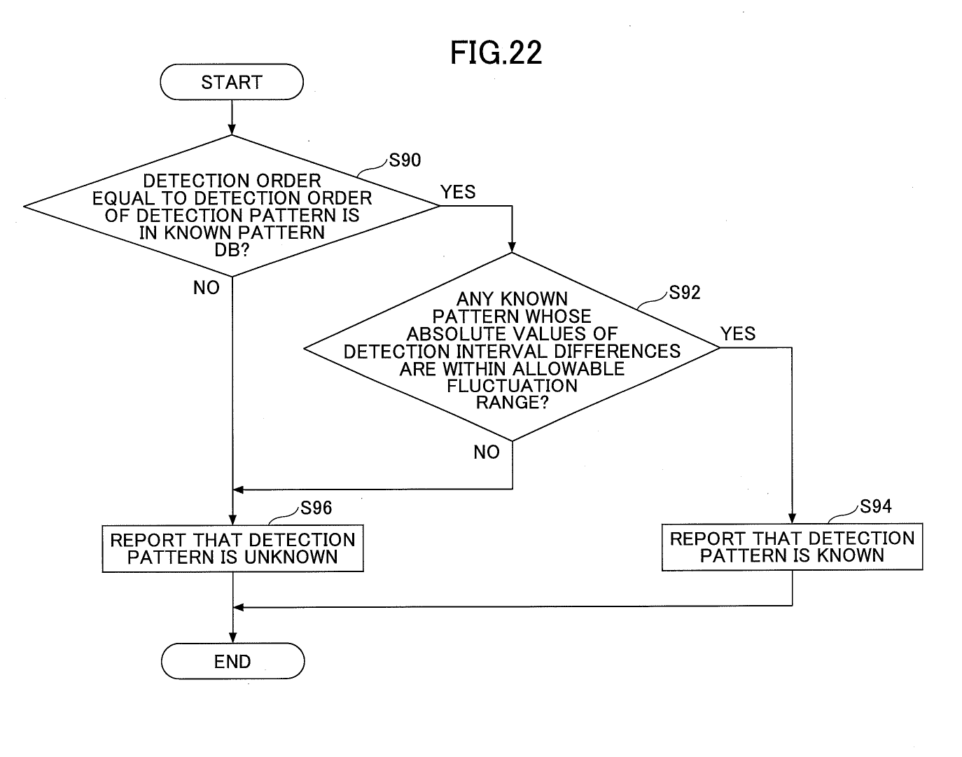

Next, a description is given with reference to FIG. 22, of a detection process according to the third embodiment. FIG. 22 is a flowchart illustrating a detection process according to the third embodiment. When this process starts, at step S90, the known determination part 18 searches the known pattern DB 17 for a known pattern having the detection order 171a that matches the detection order of a detection pattern.

In response to determining that there is a known pattern having the detection order 171a that matches the detection order of the detection pattern in the known pattern DB 17 (YES at step S90), at step S92, the known determination part 18 determines whether there is a known pattern in the known pattern DB 17 that has the detection interval 171b whose differences in the individual detection intervals of change points from the detection interval of the detection pattern are each within the allowable fluctuation range 171c in absolute value. In response to determining the presence of such a known pattern at step S92 (YES at step S92), at step S94, the known determination part 18 reports that the detection pattern known, and ends this process.

On the other hand, in response to determining that there is no known pattern having the detection order 171a that matches the detection order of the detection pattern in the known pattern DB 17 (NO at step S90), at step S96, the known determination part 18 reports that the detection pattern is unknown, and ends this process. Likewise, in response to determining the absence of such a known pattern at step S92 (NO at step S92), at step S96, the known determination part 18 reports that the detection pattern is unknown, and ends this process.

In the above-described third embodiment, a description is given of a learning process and a detection prosess that take into consideration the allowable range of fluctuations of a detection interval in the case where the order of detection does not change. In a variation of the third embodiment, a description is given of a learning process and a detection process that take into consideration the allowable range of fluctuations of a detection interval in the case where the order of detection changes. The detection apparatus 10 according to the variation of the third embodiment may have the same internal configuration as the detection apparatus 10 illustrated in FIG. 1. Accordingly, a description of the internal configuration of the detection apparatus 10 according to the variation of the third embodiment is omitted.

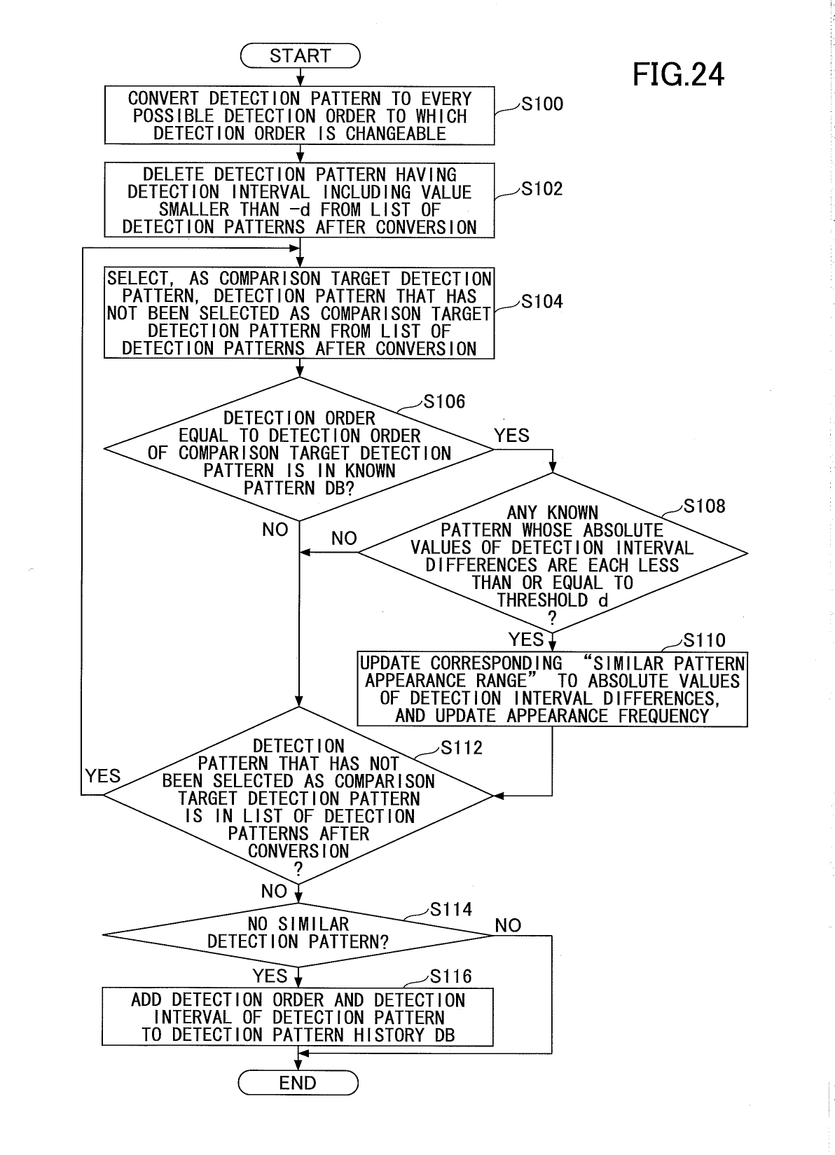

First, a description is given, with reference to FIG. 24, of a learning process according to the variation of the third embodiment. FIG. 24 is a flowchart illustrating a learning process according to the variation of the third embodiment. When this process starts, at step S100, the known pattern learning part 16 converts a detected detection pattern to every possible detection order into which the detection order of the detection pattern may be changed. As a result, a list of all detection patterns including the patterns of the converted detection order is created.

Next, at step S102, the known pattern learning part 16 deletes a detection pattern having a detection interval that has a value smaller than the lower limit value of an allowable fluctuation range, −d, from the list of detection patterns after conversion. Next, at step S104, the known pattern learning part 16 selects a detection pattern from the list of detection patterns after conversion as a detection pattern to be compared (a comparison target detection pattern).

Next, at step S106, the known pattern learning part 16 determines whether there is a detection order that is equal to the detection order of the comparison target detection pattern in the known pattern DB 17. In response to determining that there is a detection order that is equal to the detection order of the comparison target detection pattern in the known pattern DB 17 (YES at step S106), at step S108, the known pattern learning part 16 determines whether there a known pattern stored in the known pattern DB 17 that has the detection order 171a equal to the detection order of the detected detection pattern and has the detection interval 171b whose differences in the individual detection intervals of change points from the detection interval of the detected detection pattern are each less than or equal to the threshold d in absolute value. In response to determining the presence of such a known pattern in the known pattern DB 17 (YES at step S108), at step S110, the known pattern learning part 16 updates the similar pattern appearance range 203 of a corresponding detection pattern in the detection pattern history DB 20 to the absolute values of the detection interval differences. Furthermore, the known pattern learning part 16 updates the appearance frequency 202 of the corresponding detection pattern, and proceeds to step S112.

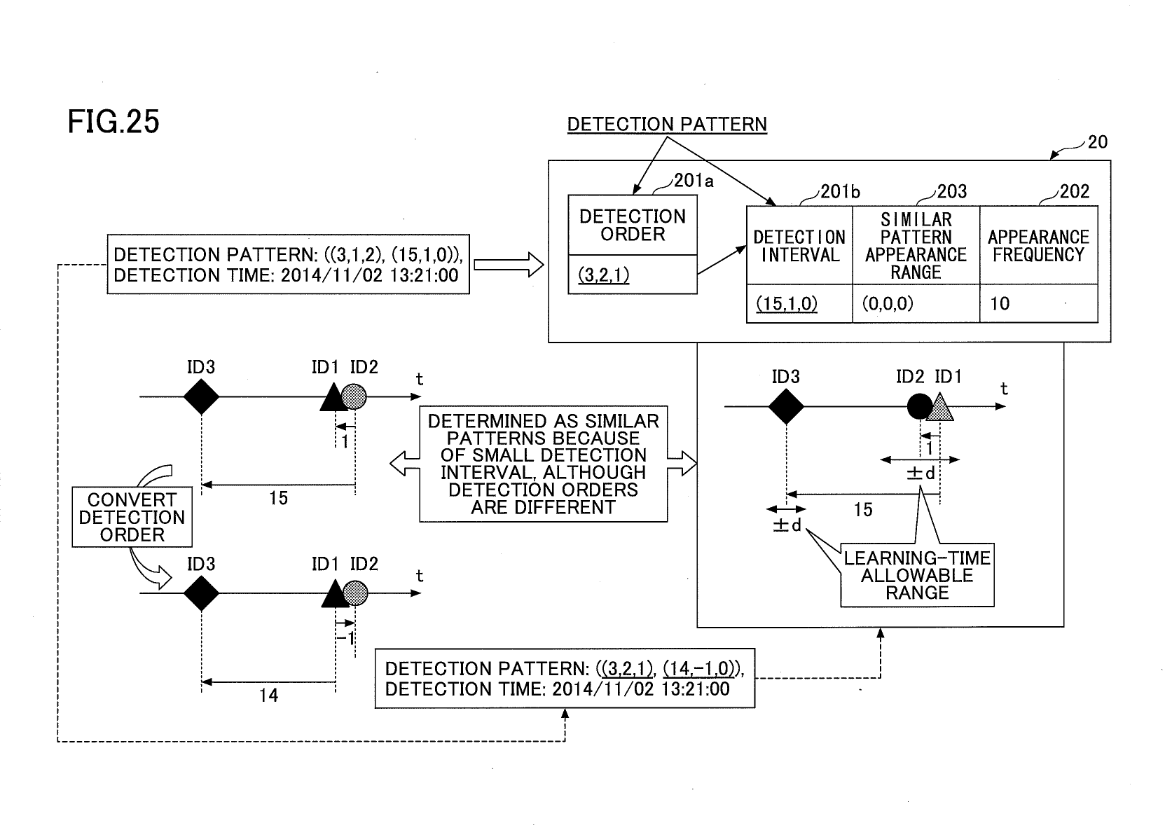

For example, as illustrated in FIG. 25, letting the allowable range of fluctuations from the detection interval be d (d≧1), the detection interval between DETECTION ID “1” and DETECTION ID “2” is small. Therefore, it is possible to determine that the detection pattern ((3, 1, 2), (15, 1, 0)) and a detection pattern ((3, 2, 1), (14, −1, 0)) different in detection order are similar patterns within the allowable fluctuation range.

Therefore, according to the variation of the third embodiment, with respect to a detection pattern having a converted detection order as well, it is possible to compare the detection pattern and a known pattern, depending on the allowable fluctuation range. Furthermore, because the comparison is performed by converting the detection pattern to every possible detection order into which the detection order of the detection pattern may be changed, it is possible to determine whether the detection pattern is known or unknown with high accuracy.

Referring back to PIG. 24, in response to determining that there is no detection order that is equal to the detection order of the comparison target detection pattern in the known pattern DB 17 (NO at step S106), the known pattern learning part 16 proceeds to step S112. Furthermore, in response to determining the absence of such a known pattern in the known pattern DB 17 (NO at step S108), the known pattern learning part 16 proceeds to step S112.

At step S112, the known pattern learning part 16 determines whether there is a detection pattern that has not been selected as a comparison target detection pattern in the list of detection patterns after conversion. In response to determining that there is a detection pattern that has not been selected as a comparison target detection pattern in the list of detection patterns after conversion (YES at step S112), the known pattern learning part 16 returns to step S104 and repeats the process of steps S104 to S112. The process of steps S104 to S112 is repeated until it is determined at step S112 that there is no detection pattern that has not been selected as a comparison target detection pattern in the list of detection patterns after conversion.

In response to determining that there is no detection pattern that has not been selected as a comparison target detection pattern in the list of detection patterns after conversion (NO at step S112), at step S114, the known pattern learning part 16 determines whether there is no detection pattern that is similar to any of the comparison target detection patterns. In response to determining that there is no detection pattern that is similar to any of the comparison target detection patterns (YES at step S114), at step S116, the known pattern learning part 16 adds the detection order and the detection interval of the detected detection pattern to the detection pattern history DB 20, and ends this process. In response to determining that there is a detection pattern that is similar to any of the comparison target detection patterns (NO at step S114), the known pattern learning part 16 ends this process.

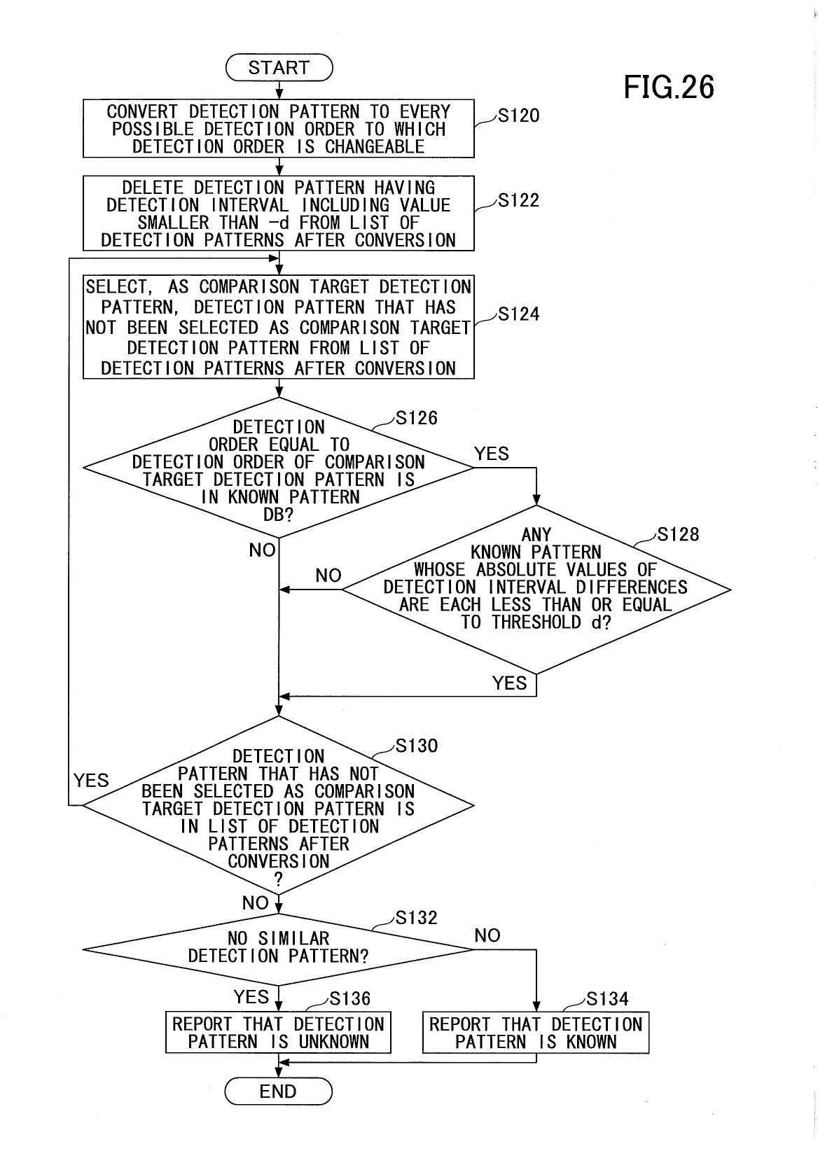

Next, a description is given, with reference to FIG. 26, of a detection process according to the variation of the third embodiment. FIG. 26 is a flowchart illustrating a detection process according to the variation of the third embodiment. When this process starts, at step S120, the known determination part 18 converts a target detection pattern into every possible detection order into which the detection order of the detection pattern may be changed, and makes a list of detection patterns. Next, at step S122, the known determination part 18 deletes a detection pattern having a detection interval that has a value smaller than the lower limit value of an allowable fluctuation range, −d, from the list of detection patterns after conversion. Next, at step S124, the known determination part 18 selects a detection pattern from the list of detection patterns after conversion as a detection pattern to be compared (a comparison target detection pattern).

Next, at step S126, the known determination part 18 determines whether there is a detection order that is equal to the detection order of the comparison target detection pattern in the known pattern DB 17. In response to determining that there is a detection order that is equal to the detection order of the comparison target detection pattern in the known pattern DB 17 (YES at step S126), at step S128, the known determination part 18 determines whether there is a known pattern that has the detection interval 171b whose differences in the individual detection intervals of change points from the detection interval of the detection pattern are each less than or equal to the threshold d in absolute value, and proceeds to step S130, regardless of the presence or absence of such a known pattern.

In response to determining at step S126 that there is no detection order that is equal to the detection order of the comparison target detection pattern in the known pattern DB 17 (NO at step S126), the known determination part 18 proceeds to step S130.

At step SI30, the known determination part 18 determines whether there is a detection pattern that has not been selected as a comparison target detection pattern in the list of detection patterns after conversion. In response to determining that there is a detection pattern that has not been selected as a comparison target detection pattern in the list of detetion patterns after conversion (YES at step S130), the known determination part 18 returns to step S124 and repeats the process of steps S124 to S130. The process of steps S124 to S130 is repeated until it is determined at step S130 that there is no detection pattern that has not been selected as a comparison target detection pattern in the list of detection patterns after conversion.

In response to determining that there is no detection pattern that has not been selected as a comparison target detection pattern in the list of detection patterns after conversion (NO at step S130), at step S132, the known determination part 18 determines whether there is no detection pattern that is similar to any of the comparison target detection patterns. In response to determining that there is a detection pattern that is similar to any of the comparison target detection patterns (NO at step S132), at step S134, the known determination part 18 reports that the detection pattern is known, and ends this process. On the other hand, in response to determining that there is no detection pattern that is similar to any of the comparison target detection patterns (YES at step S132), at step S136, the known determination part 18 reports that the detection pattern is unknown, and ends this process.

Thus, according to the third embodiment and its variation, not only a pattern that matches but also patterns that are similar to a detection pattern in detection order and detection interval are checked to determine whether the detection pattern is known or unknown, based on the allowable fluctuation range of the detection interval. As a result, it is possible to allow the fluctuation of appearance of a change point of a feature value of data to be assessed (object data), and to detect a detection pattern that is “similar” to a known pattern as being known.

According to the first or second embodiment, a detection pattern that is similar to but does not match a known pattern is determined to be unknown. On the other hand, according to the third embodiment and its variation, a detection pattern that is “similar” to a known pattern is determined to be known in view of a slight fluctuation of appearance of a detection change point of the detection pattern. As a result, it is possible to increase the effectiveness of the learning and detection of a known pattern.

### [d] Fourth Embodiment

According to the above-described first through third embodiments and their variations, the detection apparatus 10 learns or detects a known pattern based on the order of detection and the intervals of detection of change points and the allowable range of fluctuations. On the other hand, according to a fourth embodiment, the detection apparatus 10 determines whether a detection pattern determined to be known is normal or abnormal based on the result of learning of whether a known pattern is normal or abnormal. A description is given below of the detection apparatus 10 according to this embodiment.

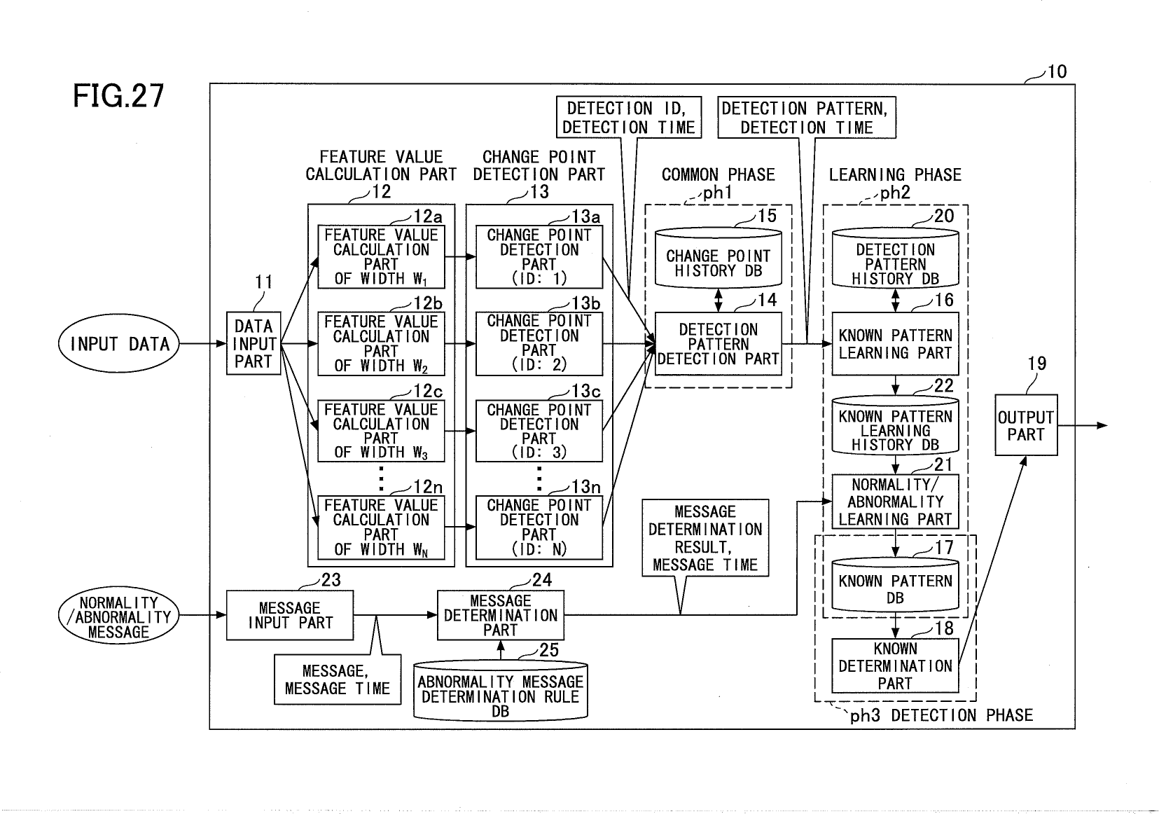

First, a description is given, with reference to FIG. 27, of an internal configuration of the detection apparatus 10 according to a fourth embodiment. The detection apparatus 10 according to the fourth embodiment includes a normality/abnormality learning part 21, a known pattern learning history DB 22, a message input part 23, a message determination part 24, and an abnormality message determination rule DB 25 in addition to the configuration of the detection apparatus 10 according to the variations of the first embodiment illustrated in FIG. 9.

The message input part 23 inputs a message of a target system or the like and the arrival time or transmission time of the message (hereinafter also referred to as “message time”). The message determination part 24 determines whether the input message indicates normality or abnormality based on message determination criteria indicating abnormality in the abnormality message determination rule DB 25.

The normality/abnormality learning part 21 determines whether there is a known pattern 221 in the known pattern learning history DB 22 that has a detection time 222 such that the input message time corresponds to a time within a given period from the detection time 222. In response to determining that there is such a known pattern 221, the normality/abnormality learning part 21 stores the determination result of the message (for example, “normal” or “abnormal”) in a normality/abnormality learning result 173 of a known pattern 171 corresponding to the known pattern 221 in the known pattern DB 17. In response to determining that there are two or more such known patterns 221 in the known pattern learning history DB 22, the normality/abnormality learning part 21 stores the determination result of the message in the normality/abnormality learning result 173 of each of the known patterns 171 corresponding to the known patterns 221.

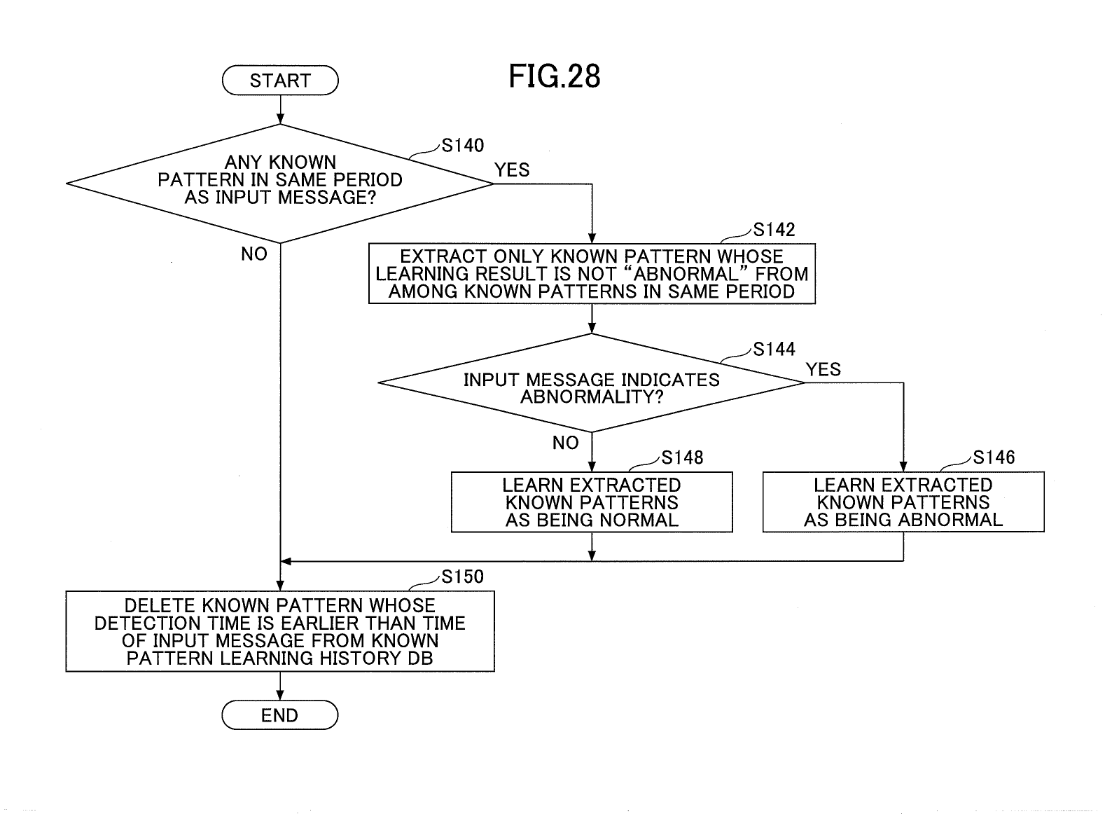

A description is given, with reference to FIG. 28, of a learning process according to the fourth embodiment. FIG. 28 is a flowchart illustrating a learning process according to the fourth embodiment. When this process starts, at step S140, the normality/abnormality learning part 21 determines whether there is a known pattern in the same period as the time of an input message (message time). Specifically, the normality/abnormality learning part 21 determines whether there is the known pattern 221 in the known pattern learning history DB 22 that has the detection time 222 such that the input message time corresponds to a time within a given period Y from the detection time 222. Here, the given period Y may also refer to the given period Y up to the detection time 222. That is, at step S140, the normality/abnormality learning part 21 may determine whether there is the known pattern 221 that has the detection time 222 such that the difference between the detection time 222 and the input message time is shorter than or equal to the length of the given period Y.

In response to determining at step S140 that there is a known pattern in the same period as the time of an input message (YES at step S140), at step S142, the normality/abnormality learning part 21 extracts only the known pattern 171 whose normality/abnormality learning result 173 is not “abnormal” from among the known patterns (determined to be in the same period) from the known pattern DB 17.

Next, at step S144, the normality/abnormality learning part 21 determines whether the input message corresponding to the extracted known pattern 171 indicates abnormality. In response to determining that the input message corresponding to the extracted known pattern 171 indicates abnormality (YES at step S144), at step S146, the normality/abnormality learning part 21 stores “abnormal” in the normality/abnormality learning result 173 of the extracted known pattern 171 in the known pattern DB 17. On the other hand, in response to determining that the input message corresponding to the extracted known pattern 171 indicates normality (NO at step S144), at step S148, the normality/abnormality learning part 21 stores “normal” in the normality/abnormality learning result 173 of the extracted known pattern 171 in the known pattern DB 17.

Next, at step S150, the normality/abnormality learning part 21 deletes information on a known pattern whose detection time 222 is earlier than the time of the input message from the known pattern learning history DB 22, and ends this process.

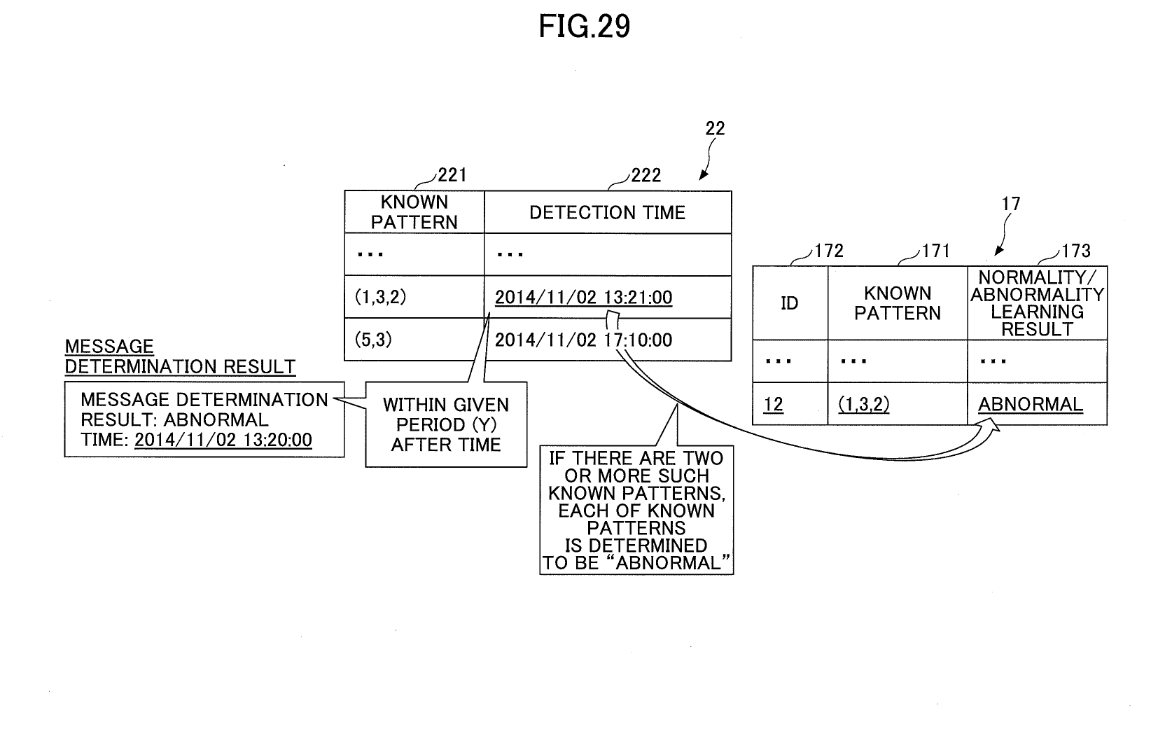

Furthermore, in response to determining at step S140 that there is no known pattern in the same period as the time of an input message (NO at step S140) as well, the normality/abnormality learning part 21 likewise executes the process of step S150 and ends this process. As a result, as illustrated in FIG. 29, it is learned whether a known pattern is normal or abnormal from the determination result of a message, and the result of the learning is stored in the known pattern DB 17.

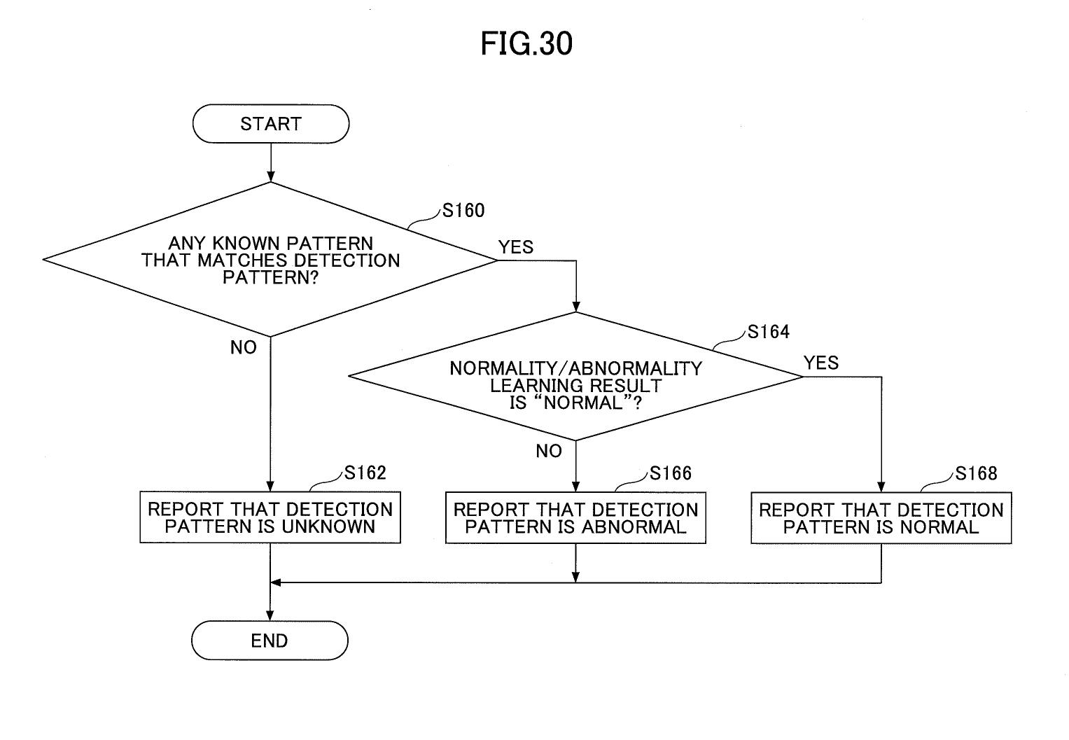

Next, a description is given, with reference to FIG. 30, of a detection process according to the fourth embodiment. FIG. 30 is a flowchart illustrating a detection process according to the fourth embodiment. When this process starts, at step S160, the known determination part 18 searches the known pattern DB 17 for a known pattern whose detection order matches the detection order of a detection pattern to be processed. In response to determining that there is no known pattern whose detection order matches the detection order of the detection pattern in the known pattern DB 17 (NO at step S160), at step S162, the known determination part 18 reports that the detection pattern is an “unknown” pattern, and ends this process.

On the other hand, in response to determining that there is a known pattern whose detection order matches the detection order of the detection pattern in the known pattern DB 17 (YES at step S160), at step S164, the known determination part 18 determines whether “normal” is stored in the normality/abnormality learning result 173 of the corresponding known pattern 171 in the known pattern DB 17. In response to determining that “abnormal” is stored in the normality/abnormality learning result 173 (NO at step S164), at step S166, the known determination part 18 reports that the detection pattern is an “abnormal” pattern, and ends this process. On the other hand, in response to determining at step S164 that “normal” is stored in the normality/abnormality learning result 173 (YES at step S164), at step S168, the known determination part 18 reports that the detection pattern is a “normal” pattern, and ends this process.

Thus, it is possible to determine detection pattern is “normal” when the detection pattern matches a normal known pattern, to determine that a detection pattern is “abnormal” when the detection pattern matches an abnormal known pattern, and to determine that a detection pattern is “unknown” when the detection pattern matches no known pattern.

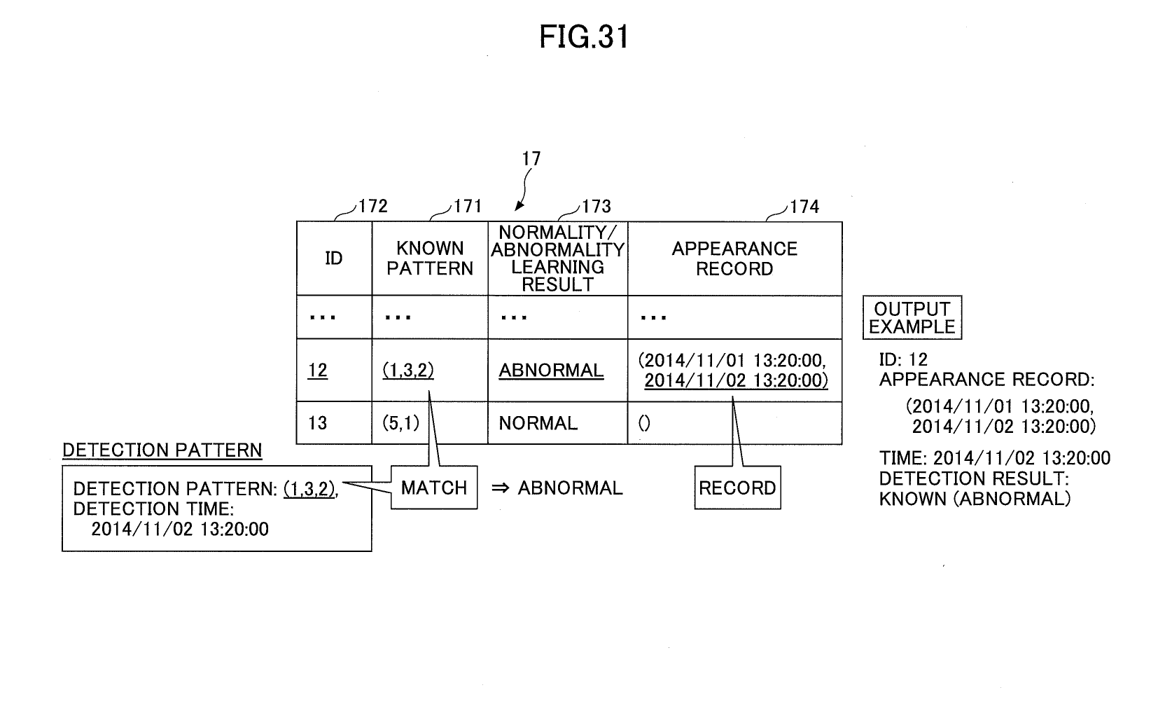

As described above, it is determined whether a detection pattern to be processed is known or unknown according to the first through third embodiments, while according to the fourth embodiment, it is possible to determine whether a detection pattern to be processed is normal or abnormal when the detection pattern is known. Thus, by learning whether a known pattern is normal or abnormal in the learning phase ph2, it is possible to report normality/abnormality information to a user when a detection pattern is known. For example, FIG. 31 illustrates the case of indicating that the determination result of a detection ID 172 of “12” is “known” (“abnormal”) as an example of a report (output) to a user. Furthermore, the information of appearance record 174 in the known pattern DB 17 may be presented as an output to user.

### [e] Fifth Embodiment

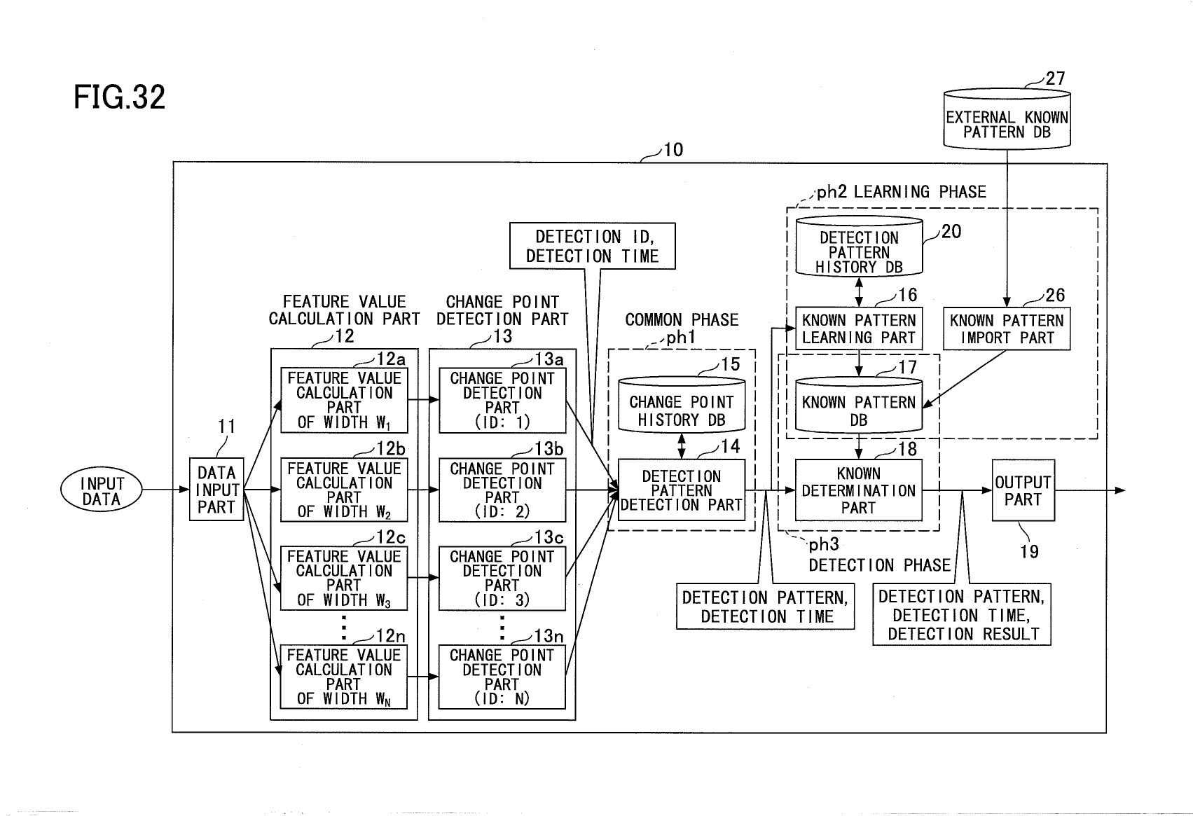

A description is given, with reference to FIG. 32, of an internal configuration of the detection apparatus 10 according to a fifth embodiment. The detection apparatus 10 according to the fifth embodiment includes a known pattern import part 26 in addition to the configuration of the detection apparatus 10 according to the variations of the first embodiment illustrated in FIG. 9. The known pattern import part 26 imports information in an external known pattern DB 27 from an external server or the like.

The known pattern learning part 16 learns whether a detection pattern is known or unknown and whether a known detection pattern is normal or abnormal based on the imported information stored in the external known pattern DB 27. Furthermore, the known determination part 18 determines whether a detection pattern is known or unknown and whether a known detection pattern is normal or abnormal based on the imported known patterns. The known determination part 18 replaces the known patterns retained in the known pattern DB 17 with the imported known patterns if the known patterns retained in the known pattern DB 17 and the imported known patterns are inconsistent with respect to normality or abnormality of known patterns.

According to the detection apparatus 10 of the fifth embodiment, known patterns are imported from an external server or the like, and a detection pattern may be learned or detected based on the imported known patterns. Furthermore, it is possible to update the known pattern DB 17 with the imported known patterns. As a result, it is possible to learn a detection pattern and determine whether a detection pattern is known or unknown in view of the known patterns imported from outside the detection apparatus 10.

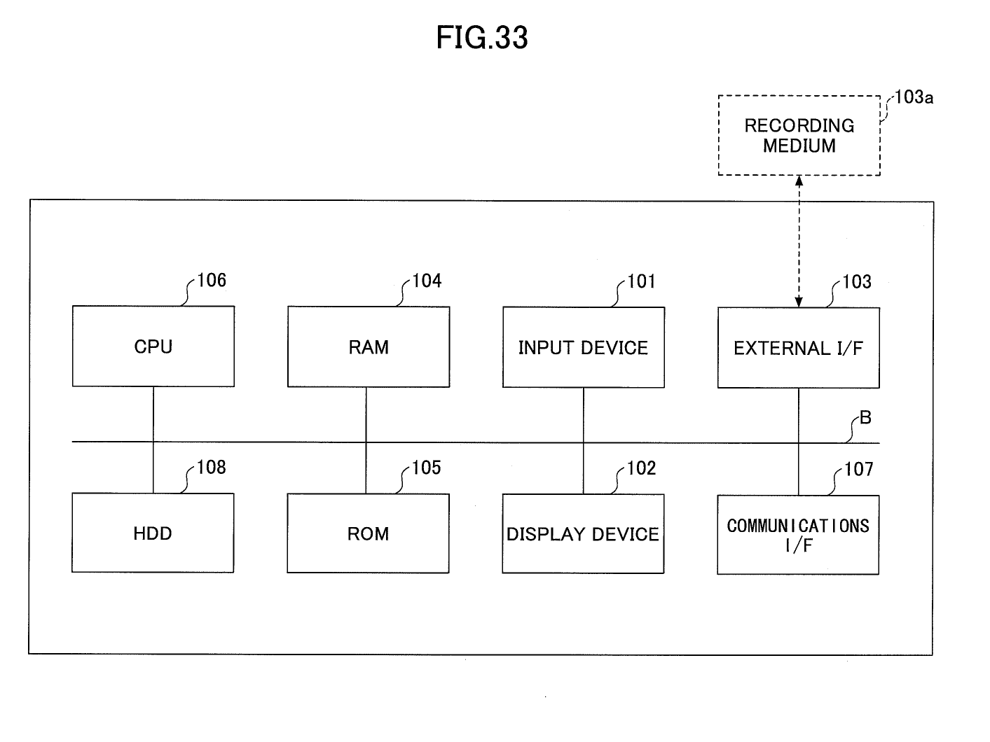

Next, a description is given, with reference to FIG. 33, of a hardware configuration of the detection apparatus 10 according to an embodiment. FIG. 33 is a block diagram illustrating a hardware configuration of the detection apparatus 10 according to an embodiment. The illustrated hardware configuration may be applied to any of the above-described embodiments and variations.

The detection apparatus 10 includes an input device 101, a display device 102, an external interface (I/F) 103, a random access memory (RAM) 104, a read-only memory (ROM) 105, a central processing unit (CPU) 106, a communications I/F 107, and a hard disk drive (HDD) 108, all of which are interconnected by a bus B.

The input device 101 includes a keyboard and a mouse, and is used to input operation signals to the detection apparatus 10. The display device 102 includes a display, and displays the results of processes. The communications I/F 107 is an interface for connecting the detection apparatus 10 to a network. As a result, it is possible for the detection apparatus 10 to perform data communications with other apparatuses (such as a device that stores the external known pattern DB 27) via the communications I/F 107.

The HDD 108 is a nonvolatile storage device that contains programs and data. The contained programs and data include basic software that performs overall control of the detection apparatus 10 and application software. For example, the HDD 108 may contain various kinds of databases and programs.

The external I/F 103 is an interface with external devices and apparatuses. The external devices and apparatuses include a recording medium 103a. As a result, it is possible for the detection apparatus 10 to read and/or write to the recording medium 103a via the external I/F 103. Examples of the recording medium 103a include a compact disk (CD), a digital versatile disk (DVD), an SD memory card, and a universal serial bus (USB) memory. For example, a program stored in the recording medium 103a may be read into the HDD 108 via the external I/F 103.

The ROM 105 is a nonvolatile semiconductor memory (storage device) capable of retaining internal data even after power is shut off. The ROM 105 contains programs and data for network configuration or the like. The RAM 104 is a volatile semiconductor memory (storage device) that temporarily retains programs and data. The CPU 106 is a processor that implements overall control and installed functions of the detection apparatus 10 by reading programs and data from the storage device (such as the HDD 108 or the ROM 105) into the RAM 104 and executing processes.

According to the detection apparatus 10, based on this configuration, the CPU 106 executes a learning process and a detection process using data and a program stored in the ROM 105 the HDD 108. The information stored in the change point history DB 15, the known pattern DB 17, the detection pattern history DB 20, and the known pattern learning history DB 22 may be stored in the RAM 104, the HDD 108, or a cloud server connected to the detection apparatus 10 via a network.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process, the process comprising:
executing a plurality of change point detection processes that detect respective change points of first time-series data with a plurality of granularities that are different in a width of a unit time;
storing, in a storage part, a first detection pattern that indicates an order of detection of the change points;
detecting change points of second time-series data subsequent to the first time-series data with the plurality of different granularities; and
generating an output that differs depending on whether a second detection pattern matches the stored first detection pattern, the second detection pattern indicating an order of detection of the change points of the second time-series data.

2. The computer-readable recording medium as claimed in claim 1, wherein the process further comprises:
determining whether to store the first detection pattern in the storage part based on a frequency of appearance of the first detection pattern with respect to the first time-series data.

3. The computer-readable recording medium as claimed in claim 1, wherein
each of the first detection pattern pattern and the second detection pattern includes detection interval information indicating a detection interval of the change points, and
the output differs depending on whether the detection interval included in the second detection pattern matches the detection interval included in the stored first detection pattern based on the detection interval information of the first detection pattern and the second detection pattern.

4. The computer-readable recording medium as claimed in claim 3, wherein
the first detection pattern includes an allowable fluctuation range information indicating an allowable range of fluctuations of the detection interval, and
the output differs depending on whether the detection interval included in the second detection pattern falls within the allowable range of fluctuations of the detection interval of the stored first detection pattern based on the allowable fluctuation range information of the first detection pattern.

5. The computer-readable recording medium as claimed in claim 3, wherein
the first detection pattern includes an allowable fluctuation range information indicating an allowable range of fluctuations of the detection interval, and
the output differs depending on whether an order of detection of the change points to which the order of detection of the change points indicated by the second detection pattern is changed matches the order of detection of the change points indicated the stored first detection pattern and the detection interval included in the second detection pattern after the change of the order of detection falls within the allowable range of fluctuations of the detection interval of the stored first detection pattern, based on the allowable fluctuation range information of the first detection pattern.

6. The computer-readable recording medium as clamed in claim 1, wherein
the stored first detection pattern includes information indicating whether an appearance of the first detection pattern is normal or normal, and
the output indicates that the second detection pattern is normal or abnormal based on the information indicating whether the appearance of the first detection pattern is normal or abnormal, depending on whether the second detection pattern matches the stored first detection pattern.

7. A detection method executed by a computer, comprising:
executing, by a processor of the computer, a plurality of change point detection processes that detect respective change points of first time-series data with a plurality of granularities that are different in a width of a unit time;
storing, by the processor, in a storage part, a first detection pattern that indicates an order of detection of the change points;
detecting, by the processor, change points of second time-series data subsequent to the first time-series data with the plurality of different granularities; and
generating, by the processor, an output that differs depending on whether a second detection pattern matches the stored first detection pattern, the second detection pattern indicating an order of detection of the change points of the second time-series data.

8. The detection method as claimed in claim 7, further comprising:
determining, by the processor, whether to store the first detection pattern in the storage part based on a frequency of appearance of the first detection pattern with respect to the first time-series data.

9. The detection method as claimed in claim 7, wherein
each of the first detection pattern and the second detection pattern includes detection interval information indicating a detection interval of the change points, and
the output differs depending on whether the detection interval included in the second detection pattern matches the detection interval included in the first detection pattern based on the detection interval information of the first detection pattern and the second detection pattern.

10. The detection method as claimed in claim 9, wherein
the first detection pattern includes an allowable fluctuation range information indicating an allowable range of fluctuations of the detection interval, and
the output differs depending on whether the detection interval included in the second detection pattern falls within the allowable range of fluctuations of the detection interval of the stored first detection pattern based on the allowable fluctuation range information of the first detection pattern.

11. The detection method as claimed in claim 9, wherein
the first detection pattern includes an allowable fluctuation range information indicating an allowable range of fluctuations of the detection interval, and
the output differs depending on whether an order of detection of the change points to which the order of detection of the change points indicated by the second detection pattern is changed matches the order Of detection of the change points indicated by the stored first detection pattern and the detection interval included in the second detection pattern after the change of the order of detection falls within the allowable range of fluctuations of the detection interval of the stored first detection pattern, based on the allowable fluctuation range information of the first detection pattern.

12. The detection method as claimed in claim 7, wherein
the stored first detection pattern includes information indicating whether an appearance of the first detection pattern is normal or abnormal, and
the output indicates that the second detection pattern is normal or abnormal based on the information indicating whether the appearance of the first detection pattern is normal or abnormal, depending on whether the second detection pattern matches the stored first detection pattern.

13. A detection apparatus, comprising
a processor; and
a memory storing a program that, when executed by the processor, to cause, the detection apparatus to
execute a plurality of change point detection processes that detect respective change points of first time-series data with a plurality of granularities that are different in a width of a unit time;
store, in a storage part, a first detection pattern that indicates an order of detection of the change points;
detect change points of second time-series data subsequent to the first time-series data with the plurality of different granularities; and
generate an output that differs depending on whether a second detection pattern matches the stored first detection pattern, the second detection pattern indicating an order of detection of the change points of the second time-series data.

14. The detection apparatus as claimed in claim 13, wherein the program further causes the detection apparatus to determine whether to store the first detection pattern in the storage part based on a frequency of appearance of the first detection pattern with respect to the first time-series data.

15. The detection apparatus as claimed in claim 13, wherein,
each of the first detection pattern and the second detection pattern includes detection interval information indicating a detection interval of the change points, and
the output differs depending on whether the detection interval included in the second detection pattern matches the detection interval included in the stored first detection pattern based on the detection interval information of the first detection pattern and the second detection pattern.

16. The detection apparatus as claimed in claim 15, wherein
the first detection pattern icludes an allowable fluctuation range information indicating an allowable range of fluctuations of the detection interval, and
the output differs depending on whether the detection interval included in the second detection pattern falls within the allowable range of fluctuations of the detection interval of the stored first detection pattern based on the allowable fluctuation range information of the first detection pattern.

17. The detection apparatus as claimed in claim 15, wherein
the first detection pattern includes an allowable fluctuation range, information indicating an allowable range of fluctuations of the detection interval, and
the output differs depending on whether an order of detection of the change points to which the order of detection of the change points indicated by the second detection pattern is changed matches the order of detection of the change points indicated by the stored first detection pattern and the detection interval included in the second detection pattern after the change of the order of detection falls within the allowable range of fluctuations of the detection interval of the stored first detection pattern, based on the allowable fluctuation range information of the first detection pattern.

18. The detection apparatus as claimed in claim 13, wherein
the stored first detection pattern includes information indicating whether an appearance of the first detection pattern is normal or abnormal, and
the output indicates that the second detection pattern is normal or abnormal based on the information indicating whether the appearance of the first detection pattern is normal or abnormal, depending on whether the second detection pattern matches the stored first detection pattern.
